(19) United States
(12) Patent Application Publication
(10) Pub. No.: US 2001/0049651 A1
(43) Pub. Date: Dec. 6, 2001

(54) Global trading system and method

(76) Inventor: Mark N. Selleck, Jersey City, NJ (US)

Correspondence Address: Otho B. Ross, Bierman, Muserlian and Lucas LLP, 600 Third Avenue, 28th Floor, New York, NY, 10016, US

(21) Appl. No.: 09/845,961

(22) Filed: Apr. 30, 2001

Related U.S. Application Data
(60) Provisional application No. 60/200,248, filed on Apr. 28, 2000.

(51) Int. Cl. G06F 17/60

(52) U.S. Cl. 705/37; 705/26; 705/27; 705/36

(57) ABSTRACT

This invention relates to a trading system and method for use on a global communications network such as the Internet and accessible by anyone with Internet access and an account. More particularly, this invention relates to a system and method for using new trading instruments, namely, a system and method for trading new specialized contracts called eContracts, dContracts and oContracts on an open virtual exchange accessible via the Internet. In one embodiment, the present invention discloses a method of trading asset-based instruments over the Internet, comprising the establishing of a plurality of instruments, each comprising a transferable contract to buy or sell the price of a standardized but nondeliverable quantity of a commodity, security, service or other asset; the establishing of an Internet Web site operated by a data processing and page serving system to operate as a virtual marketplace for the trading of the instruments; the receiving of bids at the Web site sent via the Internet from traders wishing to buy at least one of the instruments at a bid price, and offers at the Web site sent via the Internet from other traders wishing to sell at least one of the instruments at an offer price; and automatically or by private negotiation facilitating, calculating, executing, settling and recording at said Web site a transaction for the purchase and sale of at least one of said instruments when said bid price equals said offer price.

### CROSS REFERENCE TO PROVISIONAL APPLICATION

Reference is made to prior copending provisional application No. 60/200,248, filed Apr. 28, 2000, entitled “Global Trading”. Such application is incorporated herein by reference.

### FIELD OF THE INVENTION

This invention relates to a trading system and method for use on a global communications network such as the Internet and accessible by anyone with Internet access and an account. More particularly, this invention relates to a system and method for using new trading instruments, namely, a system and method for trading new specialized contracts called eContracts, dContracts and oContracts on an open virtual exchange accessible via the Internet.

### BACKGROUND OF THE INVENTION

Breakdown Of Traditional Market Activity

In the abstract, most market activity traditionally has involved:

A. Buying or selling to procure or deliver an actual asset.

B. Buying and selling futures contracts (either to guarantee or protect a position or to take a speculative position).

C. Buying and selling options (to buy future contract or asset) (either to guarantee or protect a position or to take a speculative position).

In practice, this activity traditionally has involved

A. Securities trading of stock, options and derivatives on an exchange (such as the New York Stock Exchange [NYSE], the National Association of Securities Dealers Quotation [NASDAQ], Eurex, TSE, etc.).

B. Commodity futures trading on an exchange (such as the Chicago Mercantile Exchange [CME], the Chicago Board of Trade [CBOT], LME, ToCom, etc.).

C. Business-To-Business (B2B) online trading using a centralized facilitating site accessible via the Internet (such as Enron, Metalsite, Purchasepro.com, Dovebid.com, Freemarkets, Tradeout.com, HoustonStreet.com. etc.) or using proprietary electronic links between buyers and sellers and custom, compatible application (Ariba, CommerceOne, etc.) and protocols running on computers at each respective location.

D. Business-To-Individual trading either using the Internet (e.g., Amazon.com, Bluelight.com, E-Trade) or a physical location (e.g., Wal-Mart, Kmart, Macys) as facilitator or both.

E. Individual-To-Individual Trading using 1) a facilitating agent via the Internet (e.g., eBay); 2) an otherwise facilitating agent (e.g., Sotheby's) or 3) face-to-face private negotiation (e.g., yard sales, street vendors).

### Online Brokers, ECNs, and Auction Web Sites

Many have argued that a digitizing and democratization of world markets (a swapping of pits for screens via the Internet) is at once necessary, desirable, and inevitable. Indeed, the chairman of the SEC, Arthur Levitt, uses and loves eBay and believes we will move to a global electronic financial market “in the next five years.” [Cf. “The Wired Chairman,” The Washington Post, Mar. 5, 2000, p. B7.] Furthermore, it is commonly recognized that the traditional commodity and financial markets represent the most advanced and efficient economic model for trading to date.

eBay is a Web site that offers yard-sale type items and Individual-To-Individual auction style trading. Big businesses like the big three US automakers have teamed up to create Internet-based exchanges in order to trade with each other and their suppliers online. European exchanges are using electronic trading among top-end market players (brokers and exchanges) to a much greater degree than is the case in the US, but even there, the commodity and financial markets are not immediately accessible to anyone with established credit via the Internet. No full service global Internet-based trading exchange encompassing, enabling, and transcending the extant technical boundaries and modern trading instruments of the various types of market activity itemized above has yet come into existence.

The budding Internet Business-To-Business (B2B) market, when explored, begins to overlap with the traditional commodity markets, which, in like manner, overlap with the financial markets. To illustrate their overlap, consider: “Commodities” are what businesses trade with each other; commodity exchanges like the CME trade currencies as commodities; and financial markets like the NYSE and NASDAQ use the same financial instruments (i.e., futures and options contracts) that are used on the commodity exchanges for assets like pork-bellies and rice. Currently, cattle, cocoa, coffee, copper, corn, cotton, crude oil, gasoline, gold, heating oil, hogs, lumber, municipal bonds, natural gas, oats, orange juice, palladium, platinum, pork bellies, rough rice, silver, soybean and derivative products, Treasury Bills, Bonds and Notes, various exchange indices and nine international currencies are the only type of publicly traded US “Commodity.” [See Appendix Two—Currently Traded US Commodities.] Only buyers and sellers of these specific commodities have the ability to protect, hedge, and guarantee their products using the financial instruments of futures and options contracts in the US.

It is worth nothing that security and cash/credit guarantees are a formidable barrier to transitioning the upper ends of the market to an open Internet-based exchange. Credit cards normally cannot accommodate the huge volumes and prices of trading at the B2B markets and up. Some customers are reluctant to use even credit cards for small ticket purchases under fear of fraud. Full service global trading via the Internet or otherwise requires pre-secured cash or credit guarantees by established financial institutions.

Recently, some online (Internet-based) brokerage services have been developed which provide a new “front end” to the legacy financial trading system. These brokerages, such as E-Trade, DLJdirect, Ameritrade and others, have begun to use the Internet for trading. These attempts to digitize the market are mainly aimed at a small market niche because they use the Internet basically as merely a new “front end” to legacy trading mechanisms which process customer initiated trades through a broker to a specialist on the floor of a securities exchange for manual processing. While a few costs and inefficiencies are eliminated, the bulk remain, to say nothing of the enduring middle-men and built-in delay between the moment a buy or sell order is issued by a trader and when it is processed. Customers of online brokers are not trading “at” or “in” the market but aiming at a moving target with inadequate guarantees they will get in or out (have his or her trades executed) where or when they please.

In addition to online brokerages, some Electronic Communication Networks (ECNs) such as Instinet, The Island and Archipelago have been developed. ECNs are alternative electronic trading systems that compete mainly in after-hours trading by expanding the average trading day to 12 hours (for example) and bring the radical cost and transaction efficiencies of Internet-based trading to the major players and potentially to individual investors. ECNs, which match up buy and sell orders automatically, have the potential to render market middlemen (for example, market makers on the NASDAQ exchange, specialists on the NYSE, etc.) largely obsolete or, at least, significantly change their role. An online exchange like an ECN potentially offers the advantage of 24/7 trading, use of modern financial tools (like trading futures and options contracts as well as the new eContracts, dContracts, and oContracts), streamlined processing of orders, significantly lower trading costs, greater liquidity, more accurate pricing, anonymous trading, transparent, and highly available Internet-based market trading to all traders, large and small, and for all assets classifiable as a commodity per se.

Commodity exchanges, as illustrated above, traditionally have been able to trade only a limited number of commodities thereby leaving only the owners of the specific assets they trade with the ability to protect, hedge, and guarantee their assets with financial instruments. The number and type of assets traded has been difficult to expand because under the legacy trading system, new “open outcry pits” (or areas within an existing pit) must be created for each additional commodity added, which takes large amounts of physical floor space and money. [Cf. “Survey-Stock And Derivatives Exchanges,” Financial Times, Mar. 31, 2000.]

In addition, traditionally, although futures trading has been available in various stock indices for some time (such as Standard & Poors or S&P futures) it has been difficult if not impossible in many countries but not others to trade future contracts on individual stocks. Thus, there is a clear need for single-stock futures and options trading on a global basis. Such instruments help institutions and individual investors guard against severe price swings in the market, using products that correlate directly with their stocks. Futures also help ensure more efficient price discovery for stocks, as they do with grains, Treasury bonds, and other assets.

Another problem with current securities trading is the so-called “central limit-order application.” Specialists on certain exchanges historically have not publicly disclosed the “limit orders” in his or her “application”—say, an order from a broker-dealer to sell 100,000 shares of a certain company when it reaches a certain price per share. As a result, it normally has been difficult for a retail buyer or seller to know precisely where a stock is trading at any given moment and its larger trading context of outstanding buy and sell orders which, were they known, could alter his or her trading decision(s).

Furthermore, as the legacy market mechanism has sought to revolutionize itself digitally through efforts like ECNs and extended trading hours while retaining the essential closed nature of its operation, there has come an increased risk of abuse even as disclosure becomes an even more pressing problem. For example, when stop orders near the market are filled in after hours trading when the market is thin with few players, brokerages managing the orders can manipulate the market to stop those players out of the market only to bring the market back into a normal range prior to regular trading hours. Furthermore, the interests of an individual trader may be jeopardized when a brokerage knows the number of orders to buy at market open from his own order desk and, in after hours trading, buys enough to cover these orders filling them after the close with a guaranteed spread. When the market is not determining the price of an asset there are risks of abuse. What is more, the Federal Trade Commission is concerned that the very structure of most new and existing B2B exchanges is inherently anti-competitive being formed and operated by alliances among competitors in the same industry. [Cf. “Business-Exchange Sites Raise Questions For Regulators,” The New York Times, Jul. 7, 2000.] What is needed is a trading system that offers pure disclosure of collective order books, provides open access to everyone that can establish credibility, enables said individuals and/or companies to act as market makers in the exchange as well rather than only a select few, is itself neutral to all trades, employs operating methods that provide small and medium-sized players the same tools, efficiencies, and opportunities now only available to the select professional investor and big players.

In Europe, which has been transitioning to an electronic marketplace since approximately 1990, exchanges have merged in large blocks and electronic exchange is booming. Investment Technology Group (ITG) Europe began trading on Mar. 30, 2000 on its POSIT matching system for equities listed in France, Germany, Spain, Italy, Switzerland, the Netherlands and Belgium. POSIT is a joint venture between Investment Technology Group, Inc. and Societe Generale, one of Europe's largest financial institutions. On its debut day of expanded 8-nation intra-trading, POSIT transacted shares worth $1 billion. Institutional traders throughout Europe and the UK now have access to POSIT's anonymous matching system for over 6000 different stocks matched simultaneously across eight European markets four times a day allowing them to trade directly with each other, bypassing stock exchanges and associated costs. Again, it is worth emphasizing that only big or “institutional” players are able to participate fully and directly as both a trader and market maker in their electronic exchange.

The number of companies and individuals using the Internet to bypass traditional supplier/customer-sale/trading models is rapidly increasing, from industrial manufactures and energy companies to consumer-oriented companies such as Priceline.com. For example, Metalsite.com is an Internet Web site for the buying and selling of industrial metals; Enron.com is a site for trading natural gas, electricity and other commodities like paper, coal, chemicals and fiber optic bandwidth through Internet-based direct matching of buyers to sellers, resale of third-party products, and its own purchasing activities; and HoustonStreet.com is an Internet site for over-the-counter energy trading.

Despite recent advances, however, the basic mechanics of trading on the world financial and commodity futures markets remain somewhat archaic and significantly closed. For example, in addition to the labor-intensive aspect of traditional trading, roughly 80-95% of current futures market activity involves trades on contracts that never take delivery of any underlying asset. See FIG. 12. Even trades of securities often do not result in a physical delivery of product. Traditional futures contracts, by their nature, expire after a certain amount of time, requiring the owner of a “long” contract to liquidate the position prior to expiration, or else face an obligation to take delivery of the underlying commodity. Today, traders are forced to buy in and out of futures contracts at considerable inconvenience and expense in order to achieve their objective of holding onto the price. Thus, in addition to a need for a more efficient marketplace, a need exists for new trading instruments to permit more efficient handling of the delivery obligation.

Therefore, although certain developments point to a fully integrated global 24×7×365 live Internet-based trading system accessible by any individual via any Internet device, true global trading offering open access, transaction efficiency, high liquidity, real-time price discovery, fast order execution, fairness, availability of modern financial instruments, availability of new financial instruments, and related advantages has not yet arrived.

### SUMMARY OF THE INVENTION

To overcome the aforesaid problems, the present invention provides a global trading system, herein called “GlobalTrading” or “GT”, that enables anyone to buy, sell, and/or hedge any tradable asset or service via one online interface accessible through any Internet device using a Web browser. GlobalTrading enables all traders to buy and sell, protect, and guarantee his or her positions in the market via a simple, feature-rich, inexpensive, and cash-guaranteed Web trading system.

GlobalTrading, as an Internet solution, brings brokerages, investors and wholesalers large and small together to trade with all the tools, opportunities, and efficiencies that professional investors and large players can and do have. It is a virtual marketplace that is real-time, dynamic, interactive, fair, secure, rule-based, streamlined in cost and process, and empowering.

GlobalTrading uses new trading instruments called “eContracts” (eCons), “dContracts” (dCons), and “oContracts” (oCons), and a new vehicle called “eCash”, all discussed in more detail below.

GlobalTrading enables every trader to trade on the price fluctuations of an underlying asset alone. GT enables every trader to lock in the price of any tradable asset (minus delivery and associated costs)—by buying an eContract, and then shop for the best terms of delivery and take delivery whenever the trader wants (by swapping the eContract for a dContract where any fluctuation in price since purchasing the price is offset in the conversion of eContract to dContract by virtue of the internal operating methods of the GT system) or keep or sell the specific eContract price, perhaps at a premium. Owners can sell the price while retaining control of the underlying asset and enjoy the potential benefits thereof while still managing risk. The use of a separate trading vehicle (the dContract) for those traders wishing to take delivery permits more efficient use of market mechanisms for those traders who only wish to trade a “pure” price contract (the eContract or the oContract) for investment or speculative purposes. Furthermore, GlobalTrading allows each trader to act also as a market maker by means of its exchange system.

In one embodiment, the present invention discloses a method of trading instruments based on the price of assets over a global communications system such as the Internet, comprising:

establishing a plurality of instruments, each comprising a transferable contract representing the price of a standardized but nondeliverable quantity of a commodity, security, service or other asset;

establishing an Internet Web site operated by a data processing and page serving system to operate as a virtual marketplace for the trading of said instruments;

receiving a bid at said Web site sent via the Internet from a first trader to buy at least one of said instruments at a bid price, and an offer at said Web site sent via the Internet from a second trader to sell at least one of said instruments at an offer price, or vice versa; and

automatically or by private negotiation facilitating execution at said Web site a transation for the purchase and sale of at least one of said instruments when said bid price equals said offer price.

In another embodiment, the present invention discloses a system for trading contracts over a global communications network, comprising:

a system for establishing a plurality of eCash units, each eCash unit representing a trading credit guaranteed in advance by physical or bank-guaranteed cash or credit, and each eCash unit being stored in a trading account;

a system for establishing, storing, organizing, transmitting and displaying information for a plurality of transferable eContracts, each eContract having a variable price and representing the price of a non-deliverable quantity of a commodity, security, service or other asset and each eContract further being guaranteed or paid for by said eCash units;

a system for establishing, storing, organizing, transmitting and displaying information for a plurality of dContracts, each dContract having a price and representing a deliverable quantity of and delivery terms for a commodity, security, service or other asset and each dContract further being guaranteed or paid for by said eCash units;

a system for establishing, storing, organizing, transmitting and displaying information for a plurality of transferable oContracts, each oContract having a price and representing an option to buy or sell one or more of said eContracts, and each oContract further being guaranteed or paid for by said eCash units;

a system operated through an Internet Web site for receiving and automatically facilitating, calculating, executing, settling and recording buy and sell orders in a trading forum for the purchase and sale of said eContracts, dContracts and oContracts, according to terms of private negotiation or on an odd-lot basis first and then on a first-in, first-out basis, so as to facilitate and account for trades and establish a marketplace for said eContracts, dContracts and oContracts over a global communications network;

a system for automatically and continuously settling said trades;

a system for automatically and continuously crediting and debiting said trading accounts concurrently with said settling;

a system for converting eContracts into dContracts at the discretion of owners of said eContracts who wish to take delivery of said commodity, security, service or other asset underlying said eContracts; and

a system for displaying the results of said trades remotely in real time.

### BRIEF DESCRIPTION OF THE DRAWINGS

These and other features and advantages of the invention will now be described with reference to the drawings of certain preferred embodiments, which are intended to illustrate and not to limit the invention.

FIG. 1 is a representation of a computer screen display (“screen shot”) showing visual and audio elements that are presented to a trader upon log-on to the GlobalTrading system of the present invention, illustrating an embodiment that is displayed in association with a sample America Online (AOL)™ logon screen.

FIG. 2 is a screen shot showing an initial welcome screen of the invention.

FIG. 3 is a screen shot showing details of a virtual “steel-pipe” commodity market GT trading forum that has been entered by a trader.

FIG. 4 is a screen shot showing how the details of FIG. 3 change over time and the mechanics of a trader issuing a market order for an eContract.

FIG. 5 is a screen shot showing an eCon trade request to a market maker.

FIG. 6 is a screen shot showing an eCon trade reply from a market maker.

FIG. 7 is a screen shot showing a dCon trade request to a market maker.

FIG. 8 is a screen shot showing a dCon trade reply from a market maker.

FIG. 9 is a screen shot showing a trader designating himself or herself as a market maker.

FIG. 10 is a screen shot showing an alert sent to the trader when the price of a different commodity (here, bandwidth) is approaching a stop order.

FIG. 11 shows the relation of eContract to dContract and how any fluctuation in price over time is a wash for the owner of the price in the conversion of an eCon to dCon relative to the same asset.

FIG. 12 shows the percentage of trades that did and did not take delivery on the CME Exchange for a period of one month on 5 different commodities.

### DETAILED DESCRIPTION OF THE INVENTION

### System and Business Components

Several basic physical components and business entities are used in the present invention. They are: One or more trader personal computer(s) (PCs) or Internet-access device(s) (IADs) are provided, each running a standard Web browser such as Microsoft® Internet Explorer, each in communication over the Internet with a trading Web site or portal that operates as a virtual forum and exchange. Each trader has his or her PC or IAD at home, at the office, or elsewhere and has an agreement with an Internet service provider (ISP provider) such as America Online (AOL)® to gain access to the Internet. In addition, a specialized Internet Web site is established as a virtual “exchange” to transact trading in contracts. In the alternative, an existing ISP or portal site is configured to host an exchange. Display screens presented to the trader in the preferred embodiment are described below.

### GlobalTrading—Initial Screen Sign On

The GlobalTrading (GT) style of dynamic interactive web page is designed to take the place of or, at least, bring commodity, stock, futures and options markets to the layman and professional investor alike, along with built-in efficiencies and standard as well as new financial tools. The web site has an entry page to describe how the forum pages work. It posts a disclaimer, offers links to government and its own sites on fundamentals of judicious trading and a “sign-up” link. The “sign-up” link brings the trader to information about how to set up his/her account and how to establish his/her electronic financial credit (eCash) with a participating bank. Links to online banking institutions give a trader the ability to establish eCash immediately.

### eCash

eCash is legal tender—money in the bank or funds guaranteed by a bank to serve as an electronic financial credit either for making binding financial commitments through privately negotiated agreements (see eContract, dContract and oContract below) or to purchase products or services offered, at least on GT, if not online in general. A bank takes a deposit in physical cash, a liquid money market, a time deposit or a checking, savings or other account. The bank gives the depositor an account number and an electronic pass code. The basics of these accounts are that credits and debits are based on trading positions and profits as the market moves, potentially each second. One's eCash balance goes up or down based on those moves relative to positions taken. An eCash account must be set up before any trading is done, and the trader must read warning and disclaimer pages and agree to posted rules.

eCash is currency in the virtual world and is used as ubiquitously as cash in the real world. A trader's eCash account is updated with market movements relative to new positions he or she takes and his or her open positions as they happen in real-time. Settlement occurs in real time and in the traditional sense, at least, once a day. Note: settlement in GT does not have the same significance as in the current exchanges. The GlobalTrader's portfolio balance, which updates in real-time marked to market moves is the same as it is at settlement time even if settlement were not done. Settlement occurs at least once daily as a means to determine yield and generate technical evaluative information consistent with current market analytics.

A trader may use the balance of his or her eCash account to pay for products or services offered online, take additional market positions, keep eCash on hand or transfer part or all the balance (dollars or equivalent foreign currency) to his or her individual bank account or elsewhere.

### GlobalTrading Account

Once a trader has established his or her eCash account and now has a password or code to access the forum, he/she simply clicks on the member's icon to enter the menu page listing all the markets into which a trader could enter. A help link brings up details about all aspects of the forums and definitions of all lingo. A simulation page showing how a “widget” trading page worked shows a fantasy or past recorded market at work and allows the trader to dynamically and reciprocally interact, making trades and watching profits and loss with no risk. This area is accessible to non-members and members alike to demonstrate what trading in the markets, in general, and trading in GlobalTrading, in particular, is like. This allows the individual to determine rationally if trading in world markets is something that interests him/her before he or she gets eCash and begins to trade.

At the menu page, the trader is able to customize what he or she is looking at—the environment. Many markets are shown at the same time with a persistent quote window that travels with him/her online as the trader moves from screen to screen. The trader may also customize his/her environment to pop-up limit notifications when the market reaches a specific level. Immediately when the market hits a pre-defined user and/or system level, a window pops up stating the market and current price and asks: “Would you like to access this GT forum?” with a “Do It” action button alongside to click for “yes.”

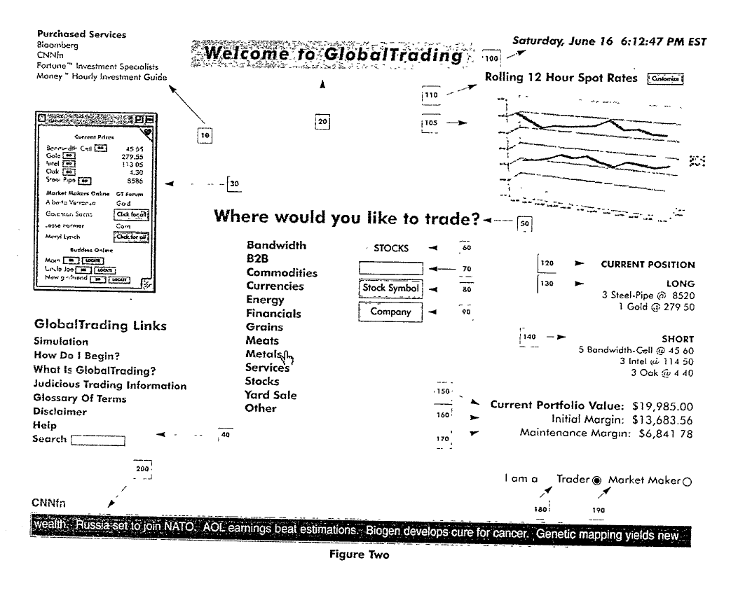

The GT page has a listing of all the markets available at that time for trade. See FIG. 2. For example,

In a preferred embodiment, the first page has the following listings:

Bandwidth

B2B

Commodities

Currencies

Energy

Financials

Grains

Groceries

Meats

Metals

Services

Stocks

Yard Sale

Other

If the trader selects “metals”, for example, the trader is taken to a sub page that gives a choice of:

Copper

Gold

Iron

Palladium

Platinum

Silver

Steel

Tin

etc.

If the trader selects the “Steel” link and then “Steel-Pipe” from the sub menu, he/she is brought directly into the “GT-Steel-Pipe” forum where he/she sees the latest trades, his or her prices, the current price, and central order books for eContracts and oContracts. See FIGS. 2-10. The trader watches and interacts dynamically with the market as it happens in real-time, like in a chat forum. Trades are automatically matched to his or her counterpart thereby closing out both positions. All pending and active bids and offers are listed in the specific forum's central order book displays for eCons and oCons respectively.

If the trader selects the Stock icon, structured hierarchical menus are available to navigate, but to get directly to the specific stock trading floor of his or her choice, the trader simply types the symbol code or name and hits the appropriate action button, reading “stock symbol” or “company,” to be brought to the desired stock trading GT forum. For example, if the trader wanted to enter the IBM GlobalTrading forum, he/she would type “IBM” and then click either “symbol search” or “company search” (IBM's symbol and name are the same) to be brought directly to the GlobalTrading-IBM trading forum where current prices, bids, asks and trades are displayed on the trader's screen live, in real-time.

### eContracts and dContracts

One important feature of the invention is that it distinguishes between and facilitates both traders that want or need to take delivery and those that do not. In traditional futures markets, each futures contract carries a delivery obligation that matures at a definite time in the future.

An “eContract” or “eCon” is a new trading instrument that represents a “pure” price for an underlying but non-deliverable asset such as a commodity, security or service.

The present invention separates the delivery obligation into a new trading instrument called a dContract. Taking a “long” position in a dContract is buying a dContract or dCon.

Taking a long position in an eContract is buying an eContract or eCon. eContracts are privately negotiated, publicly-traded agreements based upon guaranteed value that enables both parties to exert greater and more direct influence over terms of trading and price. No trader can or will ever take deliver of the underlying asset when trading strictly in eCons, but trading activity (unless a wash) will either increase or decrease the amount of eCash he/she has. The current eCon price is the present price of an asset based on its actual “on-the-spot” price and therefore does not expire like a traditional commodity or futures contract. eCons can also be described as guaranteed counterparty-to-counterparty cash/credit exposures between agreeing financially established concerns. Technically, a trader does not buy an eCon; he/she reaches a private agreement to trade in the GT forum and the value of that trade is guaranteed and accounted by GlobalTrading.

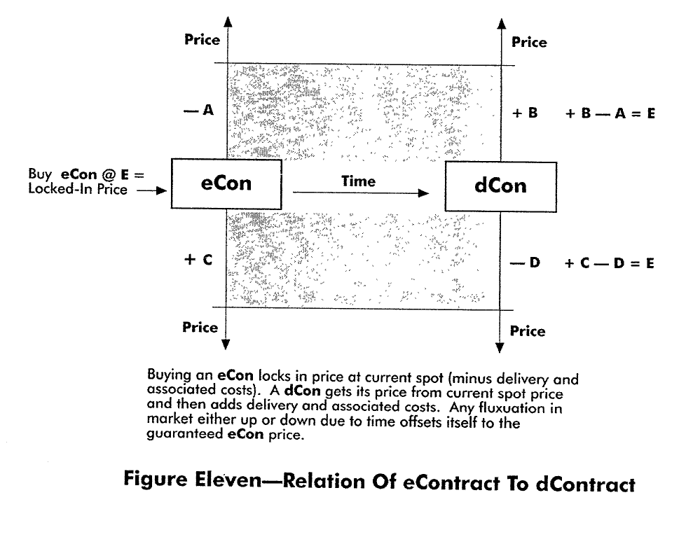

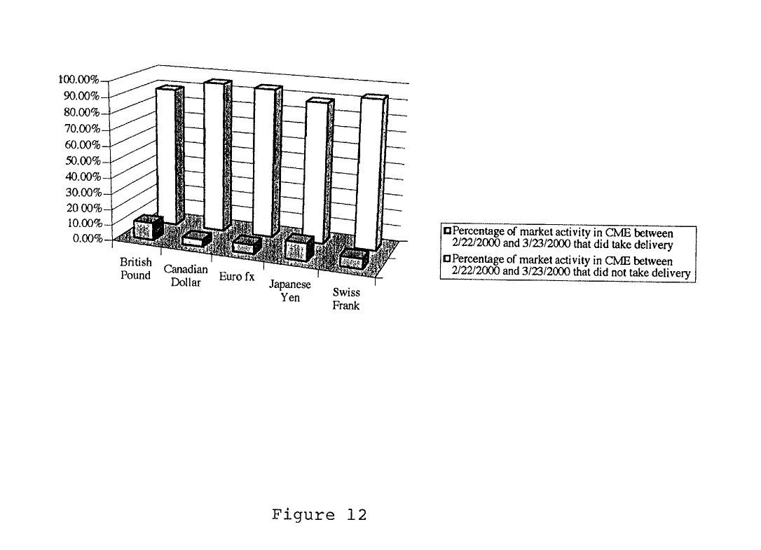

eCons are a novel and powerful financial tool with many creative applications available to both professional and laymen investors. Not only are eCons useful to those who enjoy speculating in the markets, they are also useful to those who have traditionally used future markets to hedge themselves for actual future purchase or sale of an underlying asset. eCons are a highly-liquid and inexpensive alternative to future contracts in general and especially to those traders who neither want nor need to take delivery, which is most traders. See FIG. 12. An advantage of this forum is that unlike the commodity and stock exchanges, GlobalTrading enables immediate, anonymous, guaranteed, transparent, low-cost, pure electronic trading on price fluctuation of an underlying asset, commodity, stock or indices (for a very small cost per transaction or other cost calculating mechanism) without the high costs and difficulties of buying in and out of future and/or option contracts and dealing with logistics and costs of delivery. An eCon is the guaranteed value of the trade—guaranteed by actual money or credit in a federally regulated bank. Because of their guaranteed nature, eCons offset dCons ensuring the negotiated dCon price is consistent with current spot price (minus delivery and associated costs). eCons are purchased and held long or sold and held short with minimum margin amounts to control. See FIG. 11.

Consider this example of the relation between eContracts and dContracts: One eCon of gold controls the underlying value of 100 ounces of gold. Initial margin requirement are 2.5% traded at 10 cent “tick” increments and the current spot price is 279.90. Each tick is worth $10. Given this scenario, a trader would need a minimum of $699.75 in eCash to lock control of the price of one eCon of gold at the current spot price. Suppose a watch company needs to purchase 100 ounces of gold to accommodate upcoming production of watches. Examining the market, the company sees that gold has been fluctuating between 269.70 and 287.30 over the past several months. Conflicting market factors make it difficult to predict whether the price of gold will rise or fall. On one hand, a major gold mine was forced to suspend production because of a landslide with no hope of returning to normal production soon. On the other, a new vein of gold is discovered and plans to go into production soon. The watch company feels comfortable with the current spot price of gold and wants to protect itself from volatility in the market by locking-in that price. The watch company buys one eCon of gold at 279.90 and $699.75 of its eCash is immediately tied up to secure the trade.

Scenario one: Production is delayed at the new mine causing further decrease in global supply of gold which rises to a spot price of 300.20. When the watch company wants delivery, it negotiates with online GT market makers and finds an acceptable delivery cost of $200 with a trusted market maker. The watch company buys a dCon from said market maker at the current spot price of 300.20 and upon their accepting the terms of the dCon as negotiated with the market maker by clicking “accept”, the GT system immediately sells their eCon at the current spot price. The watch company's eCash account is debited $30,220 ($30,020+$200=$30,220) and credited $2,030 for sale of one eCon at 20.30 above guaranteed price. The watch company's eCon guaranteed its price (minus delivery and associated costs) and protected itself against the sudden upsurge in market price thereby saving itself the $2,030 more it have had to pay if it had not locked in its price with an eCon.

Scenario two: The new vein of gold is larger than anticipated. Production more than offsets the decrease in supply from the disabled mine. The spot price of gold drops to 263.30. Similar to above scenario, the watch company finds a market maker to deliver for $200, purchases a dCon at current spot price and upon their accepting the terms of the dCon as negotiated with the market maker by clicking “accept”, the GT system immediately sells its eCon at the current spot price. The watch company's eCash account is debited $26,530.00 ($26,330+$200) and $1,660 for sale of one eCon at 16.60 below guaranteed price. Like the above example, the eCon counterbalances the value of the dCon guaranteeing the watch company the price they felt comfortable with, even though in this example, the watch company paid a premium to manage its risk and guarantee its price. This is a simple example. Perhaps next time the watch company will hedge itself in a more sophisticated way using the same tools with potentially better results.

The values of eCons and dCons counterbalance each other but are different. The purchase of a product for delivery is separate from entering into an eContract even though eCons and dCons off-set each other's price equally relative to the value of an underlying asset in a guaranteed way—the dCon price comes from the eCon market. On one side, eCons allow one to completely offset a position to guarantee or protect it without relinquishing control of the underlying asset. One gives up the price, but still controls the asset and the voting rights, dividend payments, or other benefits of retaining control. On the other, dCons allow one to take a price guaranteed by an eCon and shop for best terms of delivery. There are variables associated with dCons, such as delivery costs, logistics, risk of spoilage, insurance, etc., that are simply not an issue when trading at the spot price—in eCons. eCons will not replace dCons—farmers will still have to sell their cotton. Buyers will still need to take delivery of product. The idea behind eCon and dCon-based trading is providing a single interface and exchange system to place, protect, and hedge positions as well as take/arrange delivery of assets—a full-featured, cash-guaranteed trading system with a built-in hedging mechanism.

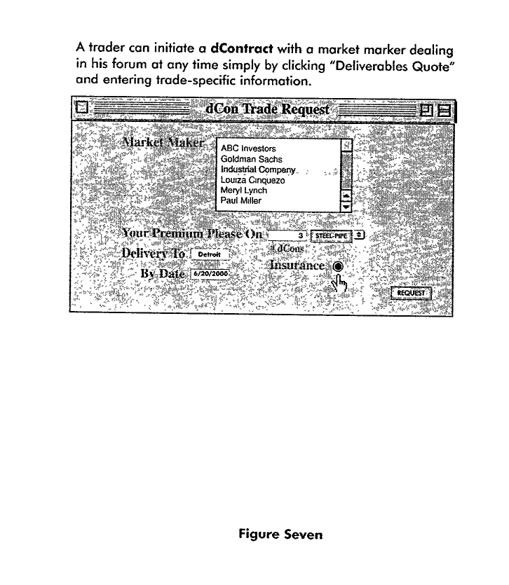

eCons are guaranteed by the GlobalTrading system in cooperation with the bank(s) by means of which respective eCash accounts were created. Buyers and sellers trading for delivery bear the responsibility, cost, and risk associated with delivery as hammered out in his or her private agreements with the individuals or companies acting as market makers in the GT system. See FIGS. 7-9. As shown above, one advantage of eCons is that they enable an investor to lock in a price and then shop for the best delivery agreement (dCon) he/she can arrange with any up or down swing in the market becoming a wash in the swap (conversion) of eCon to dCon.

GlobalTrading is merely a facilitating mechanism and remains neutral to all trades except with respect to the strict systemic rules by means of which it is self-regulated and settles all accounts. Each GlobalTrading forum provides links to online market makers.

### oContracts

An “oContract” or “oCon” is an option to buy an eContract. The oCon price is a fee that is charged by a seller of the option. For that premium the buyer has the right to buy (call) or sell (put) an actual eContract at a specific price by a specific date in the future. The current spot price of an oContract is continuously calculated by the GT system and displayed along with all pending and active orders for oContracts in the oContract central order book of a specific GT forum. oContracts can be bought and held long or sold and held short with individual portfolio balances increasing or decreasing based upon the marked to market price relative to their long or short market position.

In GT, oContracts have no initial intrinsic value, but formulas (similar to options pricing formulas) are used to calculate their price automatically based upon time value and volatility value. The depreciation of both time value and volatility value of an oCon is in direct relation to fluctuations in spot price of the underlying asset the price of which the oCon is an option to buy. oCons could develop intrinsic value, but initial pricing generated by the GT system would factor in no intrinsic value. Time value depreciates itself. Volatility value depreciates on itself and time. Generally, the value of the oCon each moment is calculated by a formula based on the ratio value of the period of time remaining in the option and the average volatility value of the preceding days over the period of time of the initial option itself and by adding in any appreciated intrinsic value. For example, say an option is for 30 days. Its value each day is calculated by a formula based on the ratio value of number of days remaining, say 27, and its relation to the average volatility of the past 30 days and by adding any appreciated intrinsic value. The valuation process of the present invention is carried out in real time.

### Mechanics of GlobalTrading

The GlobalTrading forum brings average and sophisticated trader alike to a trading pit very similar to the commodity pits in the mercantile exchanges without having to be there physically. This is a more efficient way to conduct business and results in a much more liquid market directly accessible to the individual. Large brokers and businesses trade directly with each other, reducing trading costs. In addition, the GT system is also useful to brokers because it provides them with a specially designed forum to provide for-fee expert market analysis and other premium services.

In a feature of the invention, prices are only dictated by supply and demand. The GlobalTrading system has no control over prices except to set the rules with regard to what orders go in and out first, his or her systemic determination of prices and trades and how settlement is done. Supply and demand will trigger all prices. Arbitrage insures that prices remain at the actual market. Arbitrage is when a trader makes his/her profits by determining variances in prices from one market maker to another and immediately buying and selling to spread the difference, thereby taking a minimal profit. The pricing is fixed and systemic. In addition, the pure price and pending and active trade disclosure of the central order books in each GT forum make it difficult if not impossible for anyone to manipulate the market for personal gain.

The GlobalTrading system and method of the invention provides a virtual meeting place accessible via the Internet that operates as a virtual exchange for the buying and selling of eContracts and oContracts.

In one embodiment, GT is established as an independent Internet Web site for receiving trading orders, automatically matching buy and sell orders, automatically executing trades, providing order tracking and logging of all orders and executed trades in real time, and settling the accounts of traders in real time.

In another embodiment, GT is established as a portion of an existing Internet Web site, such as an area of an Internet Service Provider (ISP) or portal site such as AOL or Yahoo.

In each embodiment, the GT system provides services via a centralized or cluster of distributed servers running one or more software applications that create and operate the virtual meeting place as an actual destination on the World Wide Web. The site or functional area of a site creates and enables the shell and structure of the GlobalTrading interface to any client with an Internet browser and Internet access. In addition, it accommodates participation, activity and interaction among traders as described herein.

The GT service generates and serves up pages relative to each individual trader and his or her specific needs and characteristics relative to the current market and their position(s) and customized choices as well as the absolute limits and inherent rules of the GT forum relative to their activity and participation within the whole or some part of the GT system. GT as a virtual meeting place for the purpose of facilitating exchange consists of a potentially infinite number of individual forums each where individuals gather around the trade of a specific asset. Each individual forum is similar to an individual chatroom as provided by numerous contemporary Internet Service Providers.

Individuals logged onto the GT system see the following on their individual screens (through the serving of text and images, links and pages by the GT application server to their individual Internet browsing device):

(1) many links with different areas of the GT system and elsewhere on the Internet that they can click to visit;

(2) information pages including disclaimers, rules of the GT system, advice on prudent trading, etc.;

(3) simulated trading forums which they can choose to enter where they can participate as a simulated trader or market maker interacting with a service offered and served by the GT system application where they buy and sell as pure simulation with no risk or real-world consequences to learn what trading in world markets in general and GT in particular is like;

(4) information feeds of news or market activity (such as price tickers);

(5) a persistent window which shows the current spot price of all GT forums in which they hold a position as well as any additional spot prices they wish to add in and through modifying their personal account preferences file;

(6) a persistent window with a customizable list of traders and market makers currently online and what if any specific forum they are in;

(7) general categories of where they can trade;

(8) sub-categories (of perhaps more than one level) which (at the bottom-most level) represent a number of specific GT forums which individuals can add to or enter and where, inside, individuals are gathered around the trading of eContracts, dContracts, and oContracts for a specific asset. Individuals participating in a GT forum are visible to each other according to their self-designation (trader or market maker) and account characteristics. (Individuals may choose to see and be seen only by other individuals whose portfolio balance—amount of eCash—falls within certain parameters.) When in a CT forum, an individual sees displayed all trades as they are made. Wherever an individual is when signed on to the GT forum, he or she will have displays served up by the GT system, which notify him or her about pre-defined (either absolutely by the system or by choice of the individual or both) events relative to their current position in one or more GT forums.

The number of GT trading forums open at any given time is relative to the number of assets individuals are interested in trading. Any trader or market maker can create a new forum around an objectively-definable (and pre-defined by the GT system administrator in coordination with relevant governing bodies as applicable by law as an available trading forum) asset which others signed into the GT system will see as an available forum alongside the number of forum participants. If a new asset, say tin-wire, has not had contract guidelines created by a GT system application administrator, individuals may submit requests to said administrator for a forum to be created. Of course, as a virtual exchange, items traded on the GT system and the trading itself will be subject to government regulation. Generally speaking, however, as long as there is an objectively-defined asset and one person who creates and enters a forum based on its underlying spot price, it will subsist and is possible within that forum to make puts and calls and view the current collective central order books, current ask and bid prices and number of each, change one's status from trader to market maker or vice-versa, initiate contact with a market maker to buy or sell eCons, dCons or oCons at the spot price or at a privately negotiated price that may be different for eCons and oCons. dCons will always pick up their price minus delivery and associated costs automatically from the spot price. This feature may be qualified by guidelines of the GT system as deemed necessary.

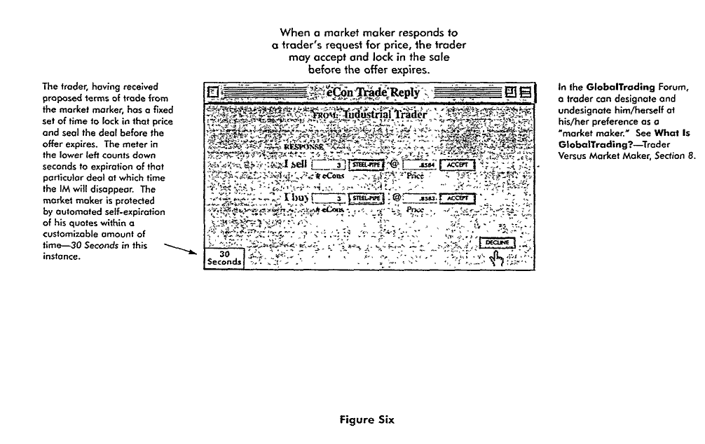

Individuals participating in the GT system can (that is, the GT server and application will facilitate and offer the service and ability to) communicate with each other by means of Web page links, email and “instant messages” (or equivalent) similar to those services provided by many contemporary ISPs but customized according to the GlobalTrading system guidelines and invention. In a preferred embodiment, communication from a market maker to a trader or market maker who initiated contact with him or her is a self-expiring instant message in order to protect the quote offered (if so done) in response to the request for a quote on a specific contract. Market makers are able through their personal account preferences to customize the amount of time their quotes will “live” after they click “send” to transmit them via instant message so that they will not extend themselves in making a quote beyond what they desire. See FIG. 6. In a slow market, a market maker may want to make the quotes last longer because there is not a lot of fluctuation in the price. In a fast-moving market, market makers will most likely want to reduce the amount of time their quotes remain an active instant message window on the side of the individual with whom they are negotiating. As long as the quote remains an active window on the side of the person to whom the market maker has submitted the quote, that person may take the market maker up on his or her offer and seal the deal which is then accounted and publicly disclosed by means of the systemic mechanism of the GT operating system.

Market makers are never able to make a quote which exceeds 90% of the eCash available in their account at that time. Traders are never able to issue an order or continue to hold positions that cause them to exceed 90% of the eCash available in their account at that time. The GT system continuously calculates these limits relative to each participant in the system and presents them as absolute boundaries to the respective individual's activity within the system. The GT System default is 50%, but in their individual account preferences, market makers and traders can customize this amount up to and including 90% of their total portfolio balance, but never more. Individuals entering a specific GT forum know that their purchase and sale of eCons and oCons at the current spot price will be automatically matched via the GT exchange system with the respective corresponding bid or offer and that the system will increase or decrease their amount of eCash and add to their long or short positions according to publicly disclosed rules of the system including but not limited to the margin requirements for maintaining a given position and what specific underlying asset a given eContract represents control of.

### Spot Price Versus Future or Forward Price

The spot price is simply the price today and is what it is if one were buying the underlying asset and taking delivery today or within 24 hours or so. A future price is not always the same. Numbers of factors exist that determine what the price of an underlying asset is in a month or two or in a year. Some factors are interest differentials between countries when talking about currencies. For example, if one commits to purchase Italian lira for delivery in one year and one makes a deposit in dollars, that earns a one year interest-rate of 5% and the seller makes the equivalent deposit of lira in an Italian bank for one year and is earning an equivalent interest-rate yield of 13%, the Italian seller is making more in interest yield on his or her money than the US dollar depositor. So to equalize the interest differential the Italian lira is discounted from its spot price to accommodate this difference and make the trade equal for a one year in the future transfer of funds. Similar to the currency example, crops are heavy during some parts of the year and not during others. So anticipated supply and demand factors over a period of time also has an impact. Inflationary factors also affect the price of metals, etc. All these factors do change over time making the price of trading something in the future more difficult because the market is pricing in premiums and discounts in the future. These myriad of factors make it more difficult to make profits when trading. Trading something that only is based on the spot price—entering into an eContract—takes all these factors out of the picture and saves one from having to determine the associated value or disadvantage. This is the current price, and one may either simply buy or sell it.

### Trading Orders Available Via the Global Trading System

Market Orders: Buy or sell at the market. Market orders to buy are automatically matched by the GT system with offers to sell at the current offering or selling price. Market orders to sell match with offers to buy at current bidding or buying price. Having guaranteed a price by buying an eCon, a trader can shop at his or her leisure and according to his or her interests for best delivery terms (dCon) with any price fluctuation offset by the original eCon purchase. Traders may also choose to act as market makers, offering buys and sells at a price of his or her choosing. A simple market order to buy, for example, will match with an equivalent number of open offers to sell as listed on the central order books for eCons and oCons displayed in the specific trading forum even if they are not all at the same price. The GT system will start from the lowest price offer to sell and match a number of offers to sell possibly going up to next offers of price to fill the entire order.

Limit Orders: Buy or sell at a limited price. A limit buy order means that the trader is limiting what price he/she is willing to pay. A limit sell order means that the trader is limiting what price he/she is willing to sell.

Stop orders: A stop order typically protects the trader from losing more money than the amount of eCash he/she has. A long position with a stop order will sell his/her position if the market goes down and hits his/her stop limit price. The next buying/bid price is given and the position closed. A short position with a stop order will buy and cover his/her position if the market goes up and hits his/her stop limit price. The next selling/offer price is paid, buying the underlying contract, closing out the short position.

### Trader Versus Market Maker

In the GlobalTrading system and method of the invention, a trader can designate and undesignate him/herself at his/her preference as a “market maker.” A “trader” is someone who trades in a market for profit of his own personal account. A market maker is a trader willing to make prices, bids and offers, to other traders to maintain market liquidity. Traditionally, market makers are typically those of larger institutions and banks who can always be in the market and are willing to make prices even when the market is very volatile. These market makers are necessary to the liquidity of the market. Market makers are usually day-traders seldom in the market for more than a few minutes. They are in and out many times over the course of a day, but they provide much of the liquidity that is necessary for a market to stay fluid. In the GT forum, each trader has the ability to be a market maker. He or she has the ability, based on his or her financial position, to establish a profile that defines what market he or she is willing to quote in and the size, number, and/or type of contracts he or she will quote on, allowing even small investors to become market makers.

The GT system will not allow a market maker to quote or transact trades on something greater than 90% of the value of his/her portfolio—their amount of available eCash. The GT system will not allow a trader to transact or maintain positions that cause him or her to exceed 90% of the value of his/her eCash. Allowing individuals to become market makers increases liquidity in the market and stimulates more activity on a 24/7 basis. Market makers have the ability to turn off his or her market making status if he or she so chooses in a way visible to others. Market makers may also designate themselves to be seen only by traders whose portfolio value falls within specific ranges. This way, traders are not wasting time initiating trades with market makers that are no longer making prices or out of his or her range. A specific online GT trading forum lists the self-designated market makers currently in the forum willing to make prices, and the live display shows all of his or her trades.

A market maker can make money even in a non-moving market because he/she is quoting a bid and an offer. The perfect situation for a market maker is lots of volume and little or no movement because they are taking a one or two tick spread all day long with no movement. The nature of the market is that as the market makers become longer in his or her portfolio, the market should be going down because that means people are selling. If the market maker is short in his hand, then the market should be going up. The art of being a market maker is to know how to buy and sell to anticipate these moves. For those that wish to stay in these forums for extended periods of time, this gives them the opportunity to assist the market with pricing and liquidity. The GT system offers traders the ability to customize the GT interface to the specific needs of the largest brokerages for free to gain his or her business. At the same time, the GT system offers small and medium-sized traders the same ability to customize their GT interface. The more traders trading, the greater the market liquidity is. The more traders in the market, the more stable the market is with fewer extreme gyrations.

### Features of GlobalTrading

A Contract Size Consistent With Traditional Exchanges/New Contracts

Parity in contract sizes makes “Arbitrage” easier. Buying one of something and selling another equal in value, versus selling one and ⅓rd of another, simplifies market activity.

In a preferred embodiment, the size of contracts on GlobalTrading is consistent with the exchanges to simplify offsetting of GT transactions. Alternatively, GT offers reduced contract sizes to open the market to smaller investors unable to overcome the large cash-up-front barriers-to-entry at current exchanges. Contract size is adjustable.

Note that this feature of GlobalTrading does not preclude the GT system from only offering contracts sold on other exchanges. Indeed, the very mechanism of GT allows it to facilitate contracts of virtually any objectively-definable asset in a contract size that best meets market demand. The GT marketplace is so open that the market itself will determine the size and number of individual markets. Basically, if a trader can get online and talk to another trader or market maker online, they are able to create a GT forum specific to their market need and begin buying and selling actual contracts and/or trade on the prices on the counter-opposed anticipations the prices will go up and down. This expansion of trading contracts into any standardized asset, of course, is subject to the GT system administrator in coordination with governing bodies. Realistically, GT includes narrowly defined assets like steel-pipe, tin-wire, British beef, Texas Beef, China Corn, US Corn, manufactured commodities like tires, transmissions, computer chips, etc. GT lends real value by enabling traders a product-specific way to hedge their position in the market against potential up or down swings in price. Spreads hedging one position against another are enabled by the GT system. Consider how valuable it would have been for British farmers to immediately begin shorting their specific position in the GT marketplace for protection in the wake of mad cow disease.

B Margin Requirements

In a preferred embodiment, margin requirements are determined by market volatility. Roughly it is based on the volatility of the specific market that is being dealt. The margin requirement is calculated by the GT system and displayed to traders and/or market makers online in each specific GT forum. Maintenance limits are the amount below which an eCash account may not go without closing the respective position. In the GT forum, maintenance requirements can be flexible because there is a built-in stop gap measure that ensures a trader does not go beyond 90% his/her amount of eCash taking into account all of their open positions relative to their respective current spot price.

C Spot Trading Is Automatic

Buyer and seller are instantaneously matched by the present invention. The debit is instantly offset with the credit of the transaction. Specific stop limits are adjusted, but may never exceed 90% of the established margin requirement. The GT system continuously calculates the cost of a trader's open positions in relation to his amount of eCash and provides a live, on-the-spot portfolio value.

For example, given a commodity with a value of $50,000, a margin of $500 and a trader with $1000 in eCash, an automatic stop measure is put into place $500 below where he/she got into the market. If the trader is not watching the market or offline and the market moves against him, the stop limit order would simply hit the next available applicable price and take the trader out of the market when the stop limit hits. The trader has the ability to adjust this stop up to 90% of his eCash—up to a $900 loss. The system always warns a trader if he/she is getting close to limit when he/she is online. When the trader is not online, a premium feature is available to automatically make a phone call or send an email, page or all three to the destination(s) of the trader's choice to notify him/her that the limit is nearing its stop. The trader then has the ability to go to a computer or Internet device, check his or her position, and add eCash or close out the position.

D Odd Lots Orders Go First; First-In, First-Out

This takes care of the small trader first in any market. For example: Say there are 155 contracts on the offer in a specific market. Five orders are in for individual sales for only 1 contract each selling at a specific price, one order for 2 contracts and one order for 3 contracts. The rest are all 10 lots and larger. If an order comes in to buy 25 contracts, then the five individual orders match first, then the two buys matched with two sells. The one order for 3 contracts respectively goes next. The rest go first-in first-out to fill out the order. The balance of 15 contracts may only fill part of an order by a larger trader. Odd lots less than 10, were they multiple, are matched first-in first-out in his or her own category. This protects the small trader.

E Settlement Of Accounts

Settlement has different significance for the GlobalTrader than it does for traders in traditional current markets. The GlobalTrader's portfolio balance updates in real-time marked to market moves and is the same as it is at settlement time even if settlement were not done. Settlement occurs at least once daily as a means to determine yield and generate technical evaluative information consistent with current market analytics.

F Markets That Can Be Traded

Basically anything that moves in price may be traded by means of the GT system and method of the present invention. If there is movement in the price of a commodity or product, service or stock, then there is the ability to trade it. The larger the range of movement, the greater the risk associated, therefore the need to manage and hedge risk. The larger the market for a specific underlying asset, the greater the liquidity potential.

GlobalTrading puts all world markets into one central market place that is transparent, completely free moving, and open and live 7/24/365 lending liquidity and price stability to the markets in general. Yoko in Japan can sell his corn at the same price as Yuri in Russia, José in Brazil, and Cargill in Chicago. The live pits of the GT exchange are directly accessible to the small farmer, the small manufacturer, the small investor, etc., regardless of location.

### Discussion of Drawings

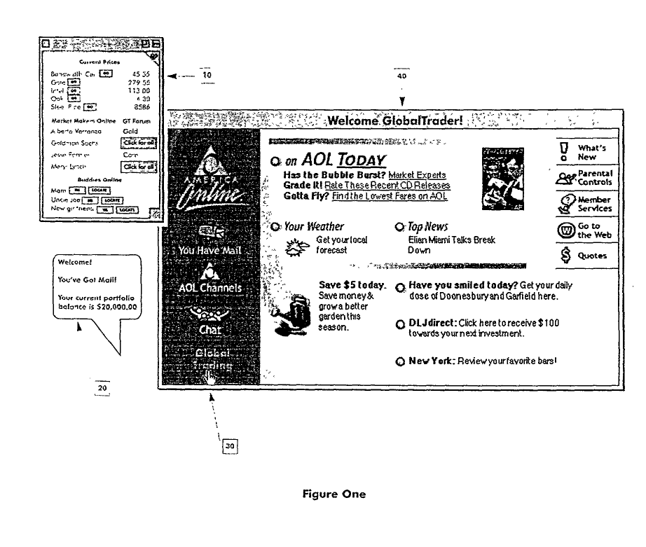

Turning now to FIG. 1, shown is a sample computer monitor display screen showing a typical “screen shot” of windows, icons and audio messages presented to a trader upon logging onto a standard Web site running the GlobalTrading system application, such as America Online or AOL™, although the logon and application service could be through another Internet Service Provider, portal or independent Web site. GlobalTrading is an independent system in any event that stands neutral to every trade except with regard to the inherent rules and procedures reflected in the mechanics of the system itself.

As an example, when the trader first logs on, the trader is presented with an audio message saying “Welcome. You've got mail. Your current portfolio balance is $20,000.” This is illustrated by a “balloon” in element 20. The term “trader” is used for simplicity sake because an individual by means of the GT system guidelines is by default a trader. It is also true that an individual can self-designate him or herself as a market maker. Furthermore, there are other settings an individual can customize relative to the characteristics of his or her online identity, how the GT interface and data present themselves in his or her view, and how he or she interacts with the system within the overall guidelines of the GT system. In this specific example and throughout FIGS. 1-10, the proper name of the individual trader is “GlobalTrader” (per 40), he is a male, and will be referred to as such hereafter. GlobalTrader and his experience is typical of any trader (male or female) and is used to demonstrate the methods of the GT system in general.

Upon entering the virtual GT system, GlobalTrader is immediately presented with a window [item 10] showing current market prices of at least all open positions in his portfolio. GlobalTrader can click on “go” to the right of the contract name and current spot price to immediately enter that specific GT forum. This window is persistent and travels with him as he navigates throughout the entire virtual GT system. This window can also include other information of interest and can be set to display such by GlobalTrader customizing his preferences via a menu option made available by the GlobalTrading application. For example, GlobalTrader does not have a position in steel-wire, but he may want to track the price either out of curiosity, because he may want to take a position, or for some other reason. In such case, GlobalTrader could modify his personal settings to constantly display the current spot price of steel-wire, etc.

FIG. 1 also shows the favorite market makers online with whom GlobalTrader prefers to deal possibly because they have been very responsive and given him good terms in their negotiation of contracts with him in the past. Per FIG. 1, GlobalTrader is technically not in the GT system yet, but the logon process itself could bring a GT member directly into the GlobalTrading virtual environment. In this example, if GlobalTrader positions his cursor over and clicks the “GlobalTrading” icon, he will be entered into the GlobalTrading system per se where he will be able to see and do things and interact with other traders and market makers as illustrated and described in discussion of these diagrams as well as elaborated elsewhere. GlobalTrader can also customize his window [item 10] to show other friends, etc., that are currently in the virtual exchange or elsewhere online.

FIG. 2 is a screen shot showing what GlobalTrader is presented with when he clicks on the GlobalTrading icon of FIG. 1. As shown, there are a number of individual items on the screen. For example,

A banner message [item 20] welcoming GlobalTrader into the GlobalTrading system;

A listing of services he has purchased [item 10];

The date and time of day to the second [item 100];

A graph of spot rate trends [item 105] which GlobalTrader can customize to display various combinations and permutations of market analytics relative to the historical trends of the spot price(s) of assets he chooses to view, compare, and/or contrast;

A list of his current open positions, both long and short [items 120, 130, and 140];

A menu of forums where GlobalTrader may choose to trade [item 50]. 50b presents GlobalTrader with the option of entering the bandwidth GT trading forum in order to enter the live virtual trading exchange of bandwidth contracts and so on as he reads down the list. The list below item 50 is an example of what a top domain level of categories of trading forums looks like;

A search box [item 40] is available for searching the GT site and web for relevant information. The search box also enables GlobalTrader to enter directly into a specific trading forum without clicking his way through the descending hierarchical menus of its more general categories by typing the name of the specific forum and striking enter or clicking some button not shown;

A search box similar to item 40 is shown in item 60 where GlobalTrader can either enter the specific name of a stock or its symbol and click on the appropriate button (80 and 90 respectively) to enter immediately the desired trading forum;

GlobalTrader's current portfolio value [item 150];

The initial margin that was required to enter into his current positions (both long and short) [item 160];

GlobalTrader's maintenance margin required to maintain his current open positions [item 170]. In this example, GlobalTrader is long 3 steel-pipe eContracts and 1 gold eContract, and he is short 5 Bandwidth-cell, 3 Intel and 3 oak eContracts.;

A radio button item indicating whether the trader is currently a trader or market maker [items 180 and 190];

A scrolling news ticker [item 200] such as may be available, for example, from CNNfn or Reuters or other information feeds he receives for free or pays for as a premium service coordinated, offered, and served by the GlobalTrading system application;

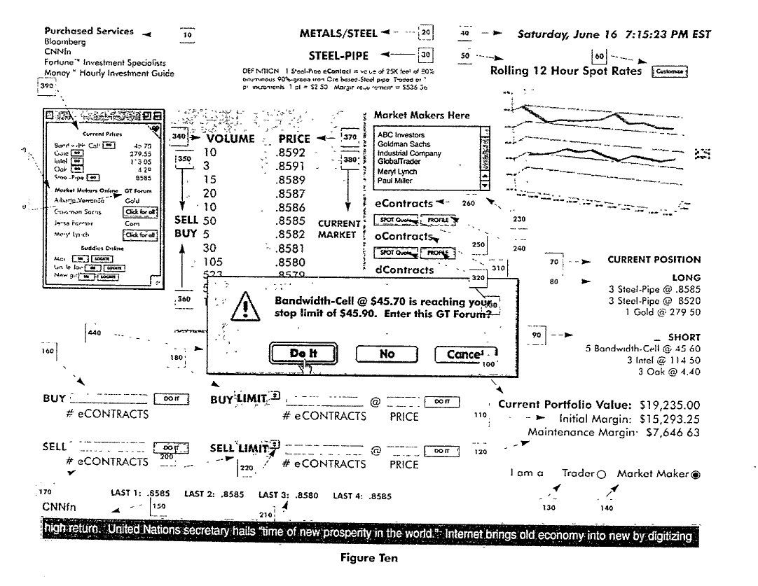

Note that GlobalTrader's Portfolio value changes from FIG. 1 to FIG. 2. In FIG. 2, time has elapsed between itself and FIG. 1, and during that time, the current spot price of Intel eContracts has increased by 0.05. This is illustrated by comparing and contrasting item 10 on FIG. 1 and item 30 on FIG. 2. GlobalTrader is short on Intel eContracts. Because the price of Intel eContracts went up, GlobalTrader's portfolio value (amount of eCash) went down an amount relative to his position (the number of eContracts he is short on that contract.) Throughout the time sequence represented by the progression from FIG. 1. through FIG. 10, the spot prices of the various positions that GlobalTrader holds and takes in the GT system fluctuate at various points. Relative to the specifics of each contract and the number of each held, GlobalTrader's eCash (portfolio value) goes up and down relative to his open positions, and these changes are reflected in his current portfolio value as displayed. The legends for the contracts made reference to in FIG. 1 through FIG. 10 are as follows:

Bandwidth-Cell

One Bandwidth-Cell eContract equals 1,000 minutes of cellular digital airtime at current market price. At initial spot price of 45.55, one Bandwidth-Cell eContract is worth $45,550.00—approximately 4 and one-half cents per minute—with initial margin of $1,138.75 traded at 0.01 point increments where each tick equals $10.00.

Gold

One Gold eContract equals 100 ounces of gold at current market price. At initial spot price of 279.55, one Gold eContract is worth $27,550.00 with initial margin of $698.75 traded at 0.01 point increments where each tick equals $10.00.

Intel

One Intel eContract equals 100 shares of Intel at current market price. At initial spot price of 113.00, One Intel eContract is worth $11,300.00 with initial margin of $282.50 traded at 0.01 point increments where each tick equals $1.00.

Steel-Pipe

One Steel Pipe eContract equals 25K feet of 80% bituminous 90%-grade Iron Ore based-Steel pipe at current market price. At initial spot price of 0.8586, one Steel-Pipe eContract is worth $21,465.00 with initial margin of $536.56 traded at 0.0001 pt. increments where each tick=$2.50.

Oak

One Oak eContracts equals 15,000 board feet of solid pressure treated oak boards. At initial spot price of 4.30, one Oak eContract is worth $64,500.00 with initial margin of $1,612.50 traded at 0.01 tick increments where each tick equals $2.50.

To explain why GlobalTrader's amount of eCash decreased from FIG. 1 to FIG. 2, we look to the definition of the Intel eContract above which is traded at 0.01 point increments and each tick equals $1. Because the spot price of the Intel eContracts went up 5 ticks, and each tick is worth $1, and furthermore because GlobalTrader is short 3 of these contracts, the market has moved against him and his eCash is decreased by the amount of $15. In general, the amount of eCash each individual member of the GT system has is calculated, accounted, and displayed (if the member in question is accessing the GT system) relative to the marking to market of their current open positions relative to fluctuations in any of the current spot prices of one or more of those positions potentially a second-by-second basis. The changes in GlobalTrader's eCash (portfolio value) throughout FIG. 1-FIG. 10 are calculated in the same way as we calculated the change from FIG. 1 to FIG. 2 above using the legend provided above.

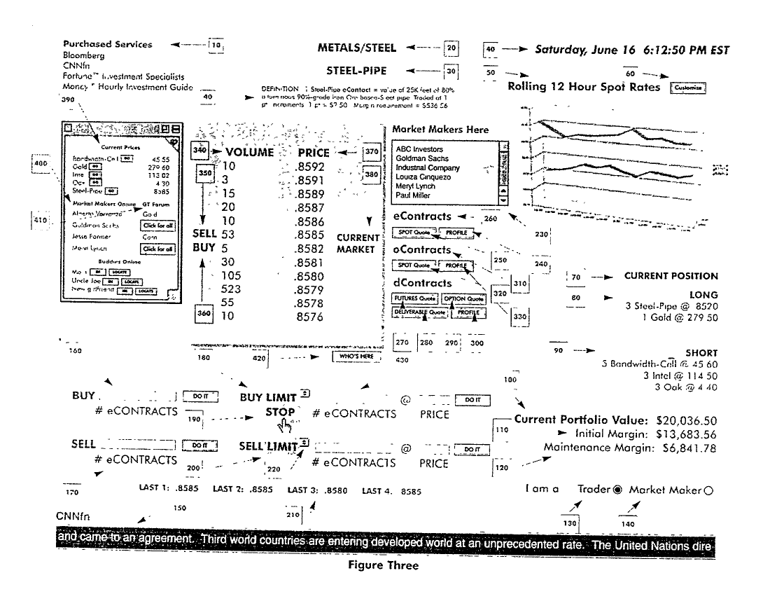

If GlobalTrader selects “metals” and then from a (not shown) sub-menu “steel”, then from another sub-menu (not shown) he clicks on “steel-pipe”, then GlobalTrader will enter the steel-pipe GT forum which is illustrated in FIGS. 3, 4, 9, and 10.

FIG. 3 shows what GlobalTrader is presented with by means of the serving GT application when he enters the steel-pipe GT forum. A specific GT forum is where all GT members congregate to participate in and/or observe the trading activity surrounding a specific underlying asset, in this case for GlobalTrader the specific GT forum is steel-pipe.

Item 10 shows services currently being subscribed to by GlobalTrader.

Item 20 shows the general category levels under which his specific trading forum falls.

Item 30 shows the name of this specific GT forum, namely “steel pipe”.

Item 40 shows the current date and time. Note that again GlobalTrader's eCash has changed based upon changes in the current spot price in the last three seconds that passed between FIG. 2 and FIG. 3. The method by means of which the GT system calculated the increase in Global Trader's eCash in this instance is explained above.

Item 50 shows a graph of historical rolling spot rates for specific assets traded in GT forums over and against other such asset(s) or any of a large number of combinations and comparisons that can be customized by GlobalTrader in his system preferences as explained above.

Items 340 through 380 are significant because they display the current market and the outstanding buy or sell orders outstanding—namely, the central order book for this forum's eContracts. Not shown is this forum's central order book for oContracts, but it is functionally similar to the eContract central order book displayed. According to this example, there are outstanding offers in the GT steel-pipe forum to sell 53 eContracts of steel-pipe at 0.8585. Again, moving up the chart on the sell side, there are outstanding offers in the GT steel-pipe forum to sell a total of 10 eContracts of steel-pipe at 0.8586, and so forth. On the buy side, there are outstanding offers in the GT steel-pipe forum to buy a total of 5 steel-pipe eContracts at 0.8582, and outstanding offers to buy a total of 30 steel-pipe eContracts at 8581. The GT system does not show how this number is divided among individual traders or market makers, but its displays the total number of open bids and calls of the central eContract order book for this steel-pipe GT forum and their respective offer prices. Item 210 shows the price of the most-recent trades in chronological order. Trades privately negotiated between a trader or market maker and a market maker are displayed in the rolling list of item 210 at commitment in real time along with all spot trades also displayed in real time.

Item 230 lists the traders in the steel-pipe forum that have designated themselves as market makers. Note that per item 130, GlobalTrader is designated a trader and not a market maker. The GT system sets “trader” as the default role of a GT member until the trader elects to change his status to that of a market maker. A market maker can do everything a trader can do, but not vice-versa. A market maker can make his or her own buy and sell quotes. Because he is identified in the system as a trader, GlobalTrader's name is not included in the list of “market makers here” [item 230]. All the same, GlobalTrader can be seen by clicking on item 420 “who's here” which lists everyone currently participating in this specific live GT forum and a link to their profile, even individuals who have no positions and are just observing market activity.

A unique feature of the GT system is that it enables individuals with an eCash account and signed onto the GT exchange to designate themselves as market makers (within the guidelines of the system as explained elsewhere) which means they can potentially quote prices to buy and sell on eContracts, oContracts, dContracts, and traditional futures and options contracts to traders and/or other market makers who initiate instant message contact with them by selecting their name in item 230 and then click on: “Spot Quote” item 250 for eCons, “Spot Quote” item 320 for oCons, “Deliverables Quote” item 280 for dCons, “Futures Quote” item 270 for traditional futures contracts, and “Option Quote” item 290 for traditional options contracts.

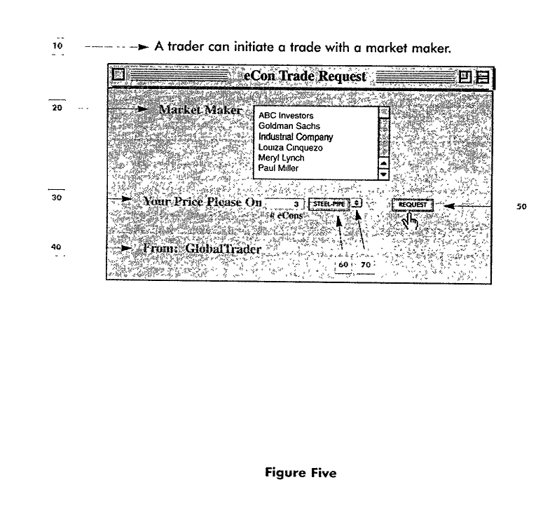

FIG. 5 and FIG. 6 partially illustrate the private negotiations facilitated by the GT system between said trader or market maker and the specific market maker in question to make a deal to either buy or sell a steel-pipe eContract. GT offers new trading instruments but facilitates use of old ones (futures and options contracts) as well.

Back to FIG. 3, by highlighting a market maker from the list of item 230 and then clicking on item 300 “Profile”, GlobalTrader would be presented with a summary of information about the market maker in question relative to their dealings in dContracts, including most likely the market makers location, ranking by other traders from past deals, what public institutions they represent, and other information the market maker wishes to provide about his or her self in order to provide any trader or market maker considering initiating a trade with him or her with information that would be useful to said person considering initiating a trade. Buttons 240 and 330 would provide information relative to the market maker's past dealings in eCons and dCons respectively, perhaps the average or accumulated volume of their trading to date, how long they have been acting as a market maker, and in which GT forums, their location, etc. For example, if GlobalTrader lives in Detroit and wants to buy or sell a dContract of steel-pipe, GlobalTrader could narrow down his choice based upon the location of the market maker in question for efficiency's sake as well as to reduce his or her delivery and associated costs. In contrast to the GT system, the CME commodity exchange, for example, uses a person to manually match a buy with the oldest long when a contract comes due regardless of their location. The logistics and cost of delivery if the buyer and seller matched are a great distant apart is not a factor considered by the fulfillment person at the CME who is charged with matching the buyers and sellers trading commodities on his or her exchange. Indeed, it is an onus placed upon the buyer and seller matched to work out the details or petition their respective clearing houses to help them find a literally closer match. This problem is avoidable in GT because of market maker profiles. What is more, if traders or market makers have had good or bad experiences with the market maker in question, the GT system enables those members to register their feedback online so that the GT system can provide it in the market maker's profile so that any trader or market maker can get a better sense of what type of market maker they are dealing with before they initiate a trade with them.

Item 160 in FIG. 3 shows that GlobalTrader can enter a number of eContracts to buy at the market. It is a market order. For example, if GlobalTrader entered 54 in item 160 and clicked the “do it” button next to it, it would buy him (give him a long position) 53 econtracts at 0.8585 and 1 eContract at 8585. If this action just mentioned were taken by GlobalTrader, the GT system would automatically match the buy of GlobalTrader with the respective sell offers of other GT member(s), crediting and debiting yielding a wash and adjusting any and all effected accounts portfolio balance(s). Furthermore, the GT system would list the trades in item 210 and instantly update the steel-pipe eContract central order book on public display in the steel-pipe forum (in particular, and in each forum where a similar market order was issued in general) to show the effect of the trade by listing first 9 offers to sell at 0.8586. Also, the GT would at the same time register the current position of GlobalTrader as now including 53 long steel-pipe eContracts at 0.8585 and 1 long steel-pipe eContract at 0.8586. It is worth nothing that GlobalTrader in the example just mentioned would not be allowed to submit this market order because he does not have enough eCash to cover margin. See items 40 and 100. The serving GT system application would respond to his attempted market order by displaying a message indicating that he does not have enough eCash for the trade giving specifics and offering suggestions for possible similar trades within the limits of his portfolio value. No trader or market maker can ever by act of commission or omission cause any action in the GT system where he or she extend themselves beyond 50% of their eCash as a system default. This percentage can be increased in GlobalTrader's system preferences to extend up to 90% of their amount of eCash, but that is the absolute limit. No GT member can spend more than what they have by virtue of the inner mechanics of the GT system and so there is no risk of loss to any member by playing by the rules of the GT exchange. GT is continuously accounting and updating all accounts relative to all open positions and fluctuations in the market. This feature is what makes the GT system a cash-guaranteed one. Of course, if GlobalTrader added sufficient eCash to his account, he would then be able to make the market order.

Item 170 shows that GlobalTrader can enter a number of eContracts to sell at the market. It is a market order. For example, if GlobalTrader entered 36 in item 170 and clicked the “do it” button directly to the right, he would be selling (giving him a short position) 5 eContracts at 0.8582, 30 eContracts at 0.8581 and 1 eContract at 8580. If this action just mentioned were taken by GlobalTrader, the GT system would automatically match the sell of GlobalTrader with the respective buy offers of other GT member(s), debiting and crediting yielding a wash and adjusting any and all effected accounts portfolio balance(s). Furthermore, the GT system would list the trades in item 210 and instantly update the steel-pipe eContract central order book on public display in the steel-pipe forum to show the effect of the trade by listing first 104 offers to buy at 0.8580. Indeed, in each GT forum where a similar market order is issued, the GT system would manage the transaction in the same way relative to the specifics of that GT forum and trade. Also, the GT would at the same time register and display the current position of GlobalTrader as now including 5 short steel-pipe eContracts at 0.8585, 30 short steel-pipe eContracts at 0.8581, and 1 short steel-pipe eContract at 0.8586. Again, It is worth nothing that GlobalTrader in the example just mentioned would not be allowed to submit this market order because he does not have enough eCash to cover margin. See items 40 and 100. The serving GT system application would respond to his attempted market order by displaying a message indicating that he does not have enough eCash for the trade giving specifics and offering suggestions for possible similar trades within the limits of his portfolio value. No trader or market maker can ever by act of commission or omission cause any action in the GT system where he or she extend themselves beyond 50% of their eCash as a system default. This percentage can be increased in GlobalTrader's system preferences to extend up to 90% of their amount of eCash, but that is the absolute limit. No GT member can spend more than what they have by virtue of the inner mechanics of the GT system and so there is no risk of loss to any member by playing by the rules of the GT exchange. GT is continuously accounting and updating all accounts relative to all open positions and fluctuations in the market. This feature is what makes the GT system a cash-guaranteed one. Of course, if GlobalTrader added sufficient eCash to his account, he would then be able to make the market order.

Item 180 shows how GlobalTrader could buy a stop or limit order at a specific price by entering the number of eContracts and clicking “do it” to the right. Stop orders protect traders by cutting them out of a moving market to minimize losses or because they cannot afford to stay in. If you are long a position and you activate a stop, your stop is below you. If you are short a position and you activate a stop, it is above you. Stop orders protect against adverse movements in the market. A buy stop order is a purchase above the current market. If the market never reaches that price, you never buy it. A sell stop order is a sell below the current market. If the market never dips to that price, you never sell it. Some traders decide to enter the market with stop orders, but generally stop orders are pain threshold limits and used to protect against loss.

With a limit order, a trader sets a particular price at which he/she wants to buy or sell. A buy limit order is a purchase below the market. If the market never dips to that price, you never buy it. A sell limit order is a sell above the market. If the market never reaches that price, you never sell it. Some traders decide to enter the market with these, but typically limit orders are profit orders. If GlobalTrader entered 3 in item 430 and chose limit from item 180 and entered the price next to item 430 of 0.8589 and clicked “do it” directly to the right of the price data entry box, the central order book of the steel-pipe forum would be adjusted to show 16 offers to sell at 0.8589, and if the current spot price were to reach that point and a buy order were executed by a trader or market maker, the GT system would close out GlobalTrader's 3 steel-pipe long positions and credit his portfolio balance accordingly (GlobalTrader's portfolio balance would be the same if the current market price reached this point given he has 3 long steel-pipe eContract positions even if he didn't sell, but, given the sale, the gain would be locked in and eCash freed to secure other positions) and debit the corresponding account(s) which were the specific buy(s) that matched GlobalTrader's sale for a wash in the GT system in general while freeing the relative margin amount of eCash being held in GlobalTrader's account to secure the long position making the same amount of eCash available to secure other trades.

Similar accounting and adjustments as described here and in much more detail would be conducted by the system relative to the trade were it a stop order, except that it would not take place unless the market reached the price designated by GlobalTrader for the stop. If a trader entered the market with a stop or limit order without a corresponding long or short position, the trade would require that the trader's account have sufficient margin in his or her eCash account to cover the position as either long or short depending on the relative circumstances. Again, the GT system would manage the transaction, updating publicly displayed central order books, crediting, debiting, securing and freeing eCash held as margin, in each respective account involved in the transaction as demanded by the specifics of the precise trade in question in a manner consistent with the methods of the GT system explained in detail above and elsewhere.

Not shown in the diagram are oContract buy and sell features or the current oContract spot price and active and pending orders which are displayed in a manner similar to how eContracts and their features are presented in the relative GT forum. Each specific GT forum has a central order book for both eCons and oCons because both are trades on pure price and have values relative to the spot price.

To contrast for a minute, dContracts, like eContracts and oContracts are strictly relative to the current spot price but do not have a central order book in the specific GT forum. Also, unlike eContracts and oContracts, dContracts sold short or bought long are guaranteed and covered by eCash, but do not appear as long or short in a given trader's current position display. This is because dContracts have terms of delivery and the deliverable as part of their very content. A dContract is in one sense a cashing out of the system, or, more precisely, the onset of activity enabled and facilitated by the GT system, but outside the strict limits of the GT system per se, namely, the actual transfer of physical assets from one party to another. One can short a dContract to sell the asset underlying the value of a specific eContract or long a dContract to buy the asset underlying the value of a specific eContract, even without having a relative prior eContract position on the given asset. The GT system fully facilitates this on the spot trading of actual product and lends the value of guaranteeing that its purchase price is the actual, publicly disclosed and traded current spot price sans delivery and associated costs in addition to other values discussed elsewhere such as locating someone who wants to trade that is in close geographic proximity. Note: nothing in the GT system precludes there being a central order book also for dContracts. Indeed, it may be useful to help traders narrow in on other specific traders or market makers who share the same immediate interest. This is customizable to market demand. Also, nothing in the GT system technically precludes a dContract from being transferable. This is customizable to market demand. There is nothing in the GT system that precludes dContracts from being facilitated, accounted, and displayed by the system as long or short relative to any given trader's current position. This also is customizable to market demand.

Returning again to oContracts, the oCon is an option to buy the price. oContracts are an option to buy an eContract where the spot price of an oContract is continuously calculated by the GT system. oContracts are facilitated commitments that are in certain ways more useful, efficient and cost-effective than traditional option contracts. In GT, option orders would have no initial intrinsic value, but a formula calculates automatically their price based upon time value and volatility value. The depreciation of both time value and volatility value of an oCon would be in direct relation to fluctuations in price. oCons could develop intrinsic value, but initial pricing by the GT system would factor in no intrinsic value. Time value depreciates itself. Volatility value depreciates on itself and time. The GT system would use an algorithm according to which the spot price of oContracts are calculated by means of a formula based on the ratio value of the period of time remaining in the option and the average volatility value of the preceding days over the period of time of the initial option itself and by adding in any appreciated intrinsic value. For example, say an option is for 30 days. Its value each day would be calculated by a formula based on the ratio value of number of days remaining, say 27, and its relation to the average volatility of the past 30 days and by adding any appreciated intrinsic value. Of course, GT's accounting is much more granular and to the second.

Orders by a trader or market maker to buy or sell an oContract at the current spot price would add the option to the buyer's and seller's long and short positions respectively while debiting the cost of the premium from the buyer and crediting the cost of the premium to the seller. oContracts are traded and accounted by the GlobalTrading system with their activity listed in their own central order book relative to each eContract of which they are an option to buy in a manner consistent with the way the GT system manages eContracts. For example, oCons can be sold short or bought long, stop and limit orders can be issued on them parallel to the way eCons are and with the same consistent accounting and management by the GT system. oCons in an individual trader or market maker's current long and short positions would be marked to market and increase (if held long) or decrease (if held short) the amount of eCash they have relative to the value (if any) they develop relative to the current spot price. If oCons are not traded at the current oCon spot price as calculated by the GT system but rather through a private negotiation between a trader or a market maker and a market maker, they may begin with intrinsic value. This intrinsic value would, upon sealing of the transaction by the market maker offering the terms and the initiator of the trade clicking “accept” in the facilitating GT instant message, be debited and credited respectively to the market maker and trader and the price of the premium would reflect this and be credited to the market maker and debited to the trader also respectively.

Other things displayed and their method and relevance are discussed above.

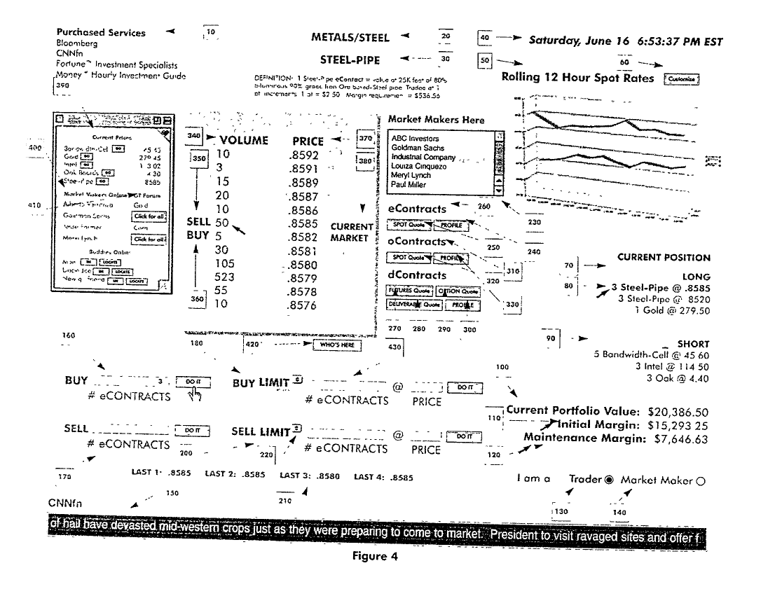

FIG. 4 is similar to FIG. 3 showing the time advanced by a little more than 40 minutes. Note how changes in spot prices from FIG. 3 to FIG. 4 as represented by item 390 in both are reflected in the changed portfolio value (amount of eCash) of GlobalTrader. The methods by means of which the GT system accounts this is explained in detail above. In FIG. 4, GlobalTrader buys 3 eContracts (see item 160, 110, 120, 80 and 350) at market. His maintenance and initial margin amounts are increased according to the eContract guidelines stated below item 30. Contract definitions and guidelines are always displayed in the GT forum of that specific contract. His current position is adjusted to reflect his added long position (item 80) and not shown, the corresponding position(s) adjusted correlatively. Note that GlobalTrader's portfolio balance does not change by his adding the three long eContracts to his current position as long as the spot price remains the same as the one he purchased (or if he had taken a short position, sold—if in this specific instance GlobalTrader had sold 3 steel-pipe eContracts, his current 3 eContract long positions in steel-pipe would have been liquidated, erasing the long position from his current position, locking in his net gain in his portfolio balance by having sold at a higher price than he bought (i.e., 8520), and freeing the margin requirement portion of his available eCash to secure other trades, transfer elsewhere or otherwise.). His portfolio balance will go up and down only as the spot price fluctuates and relative to such fluctuation as detailed above to explain the increases and decreases in portfolio value from figure to figure as spot prices change in time relative to GlobalTrader's long and short positions.

FIG. 5 shows a screen displayed to a trader who has initiated a trade of an eCon with a market maker. A trader can initiate a trade with a market maker by selecting his name in the market makers here list (item 230 on FIG. 4.) and clicking the type of trade he or she wishes to initiate, namely, a trade of an eContract, oContract, dContract or traditional futures or options contract. FIG. 5 shows a trader initiating a trade with the market maker “Industrial Company” asking Industrial Company for their price on 3 eContracts of steel-pipe. Item 70 shows a pop down list that would show other types of eContracts the market maker has customized by means of his or her GT system preferences to act as market maker in. According to the absolute limits of the GT system itself as explained elsewhere, a trader can designate him or herself as a market maker willing to make buy and sell prices on any contract sold in the GT forum that his portfolio balance can accommodate. Not shown is the instant message as it appears on the market maker's interface. The market maker sees who the message is from, can check their profile, sees specifically what contract the trader or market maker is requesting prices for. Having received the request from the trader or market maker, the market maker can either respond or decline to offer a price that will be communicated back to the initiator of the trade via instant message. If the market maker does not decline, he or she enters the prices at which he or she is willing to buy and/or sell or either and clicks “send” to respond to the trader who initiated the trade with his or her proposed terms.

FIG. 6 shows the response that appears on the interface of the trader who initiated the request, namely in this instance, GlobalTrader. The instant message shows who the market maker is, who is proposing the terms of contract and the specific terms he or she proposes. When a market maker responds to a trader's request for a price, the trader may accept and lock in the sale before the offer expires. The trader, having received proposed terms of trade from the market maker, has a fixed set of time to lock in that price and seal the deal. A count-down meter will count down in seconds the number of seconds or other time increment left till expiration of that particular deal. If the meter runs to zero, indeed, as it does, the instant message with the proposed terms of trade disappears. To make a deal with this particular market maker in this case, the trader must re-initiate a trade. In FIG. 6, GlobalTrader has 30 seconds to make a decision to either buy 3 eCons of steel-pipe at 0.8584 or sell 3 eCons of steel-pipe at 0.8583. The self-expiration of the instant message protects the market maker, and the amount of time that he or she wants his quote to be good for is customizable. In a slow market, most likely the market maker will allow the trader more time to make a decision. In a fast moving market, most likely the market maker will need to have a quick decision. Again, one unique aspect of the GT system is that anyone can potentially be a market maker—they do not have to be a seated member of an exchange. This aspect of GT de-centralizes the market place and adds tremendous liquidity inasmuch as many individual traders make themselves market makers and make profit off of one or two tick spread trades continuously for extended periods of time or otherwise. Liquidity in a market adds stability.

FIG. 7 shows a screen displayed to the trader wishing to trade a dCon. A trader can initiate a trade with a market maker by selecting his or her name in the market makers here list (item 230 on FIG. 4.) and clicking the type of trade he or she wishes to initiate, namely, a trade of an eContract, oContract, dContract or traditional futures or options contract. FIG. 7 shows GlobalTrader initiating a trade with the market maker “Industrial Company” asking Industrial Company for their price on 3 dContracts of steel-pipe. The core price of the dContract will be picked up automatically by the GT system from the current spot (eContract price) and the only additional cost will be delivery and associated costs. Not shown is the instant message request as seen by the market maker when a trader or market maker initiates a trade with him or her. The price of a dContract (minus delivery and associated costs) is the current spot price or eCon price. By buying an eCon, a trader locks in her/her price (minus delivery and associated costs) regardless of when (or if) he/she takes delivery because of the way eCons offset dCons. See FIG. 11. When an owner of an eContract wants to take delivery, they initiate a dContract trade which upon commitment the GT system automatically sells the long eCon position at the current spot price making any fluctuation in price either up or down from the time the eContract was purchased a wash for the trader swapping the eCon with a dCon because of their inherent and guaranteed relation by means of the GT system. The market maker if selling, on the other hand, has the current spot price of the entire value of the underlying asset plus delivery and associated costs as privately negotiated with the trader credited to his or her eCash. The trader making the purchase has the full value of the underlying asset at the current spot price plus delivery and associated costs as privately negotiated with the market maker debited from his or her eCash while at the same time (if the trader is swapping a long eCon with a dCon) a credit or debit as per the specific circumstance equal to the spread (if any) between the original purchase price and the current spot price at time of entering the dContract commitment thus adjusting his or her account to reflect a wash between any up or down swing in the price since the time of its purchase. eCons are a more effective way of securing a future price than traditional future contracts if the buyer does not want to be limited by an expiration date and/or does not know specifically when they will want to take delivery. Futures contracts were originally invented around the harvest times of crops and other very narrow parameters and thus have fixed close dates. Now with trader's needing similar financial instruments to protect, guarantee, and hedge assets of a different or even the same nature but on a global basis or otherwise, the more refined tool of the eContract is better suited to their intention and more efficient and cost-effective to use. A trader can enter a GT forum and meet other traders who are contracting with each other to take opposite positions on the price of something alone each with opposite anticipations that the price will go up or down. In GT, buyers can trade only on the price, which is dictated only by supply and demand (by buying an eCon), which can be swapped at any time via the GT system into a dCon without limitation minus delivery and associated costs.

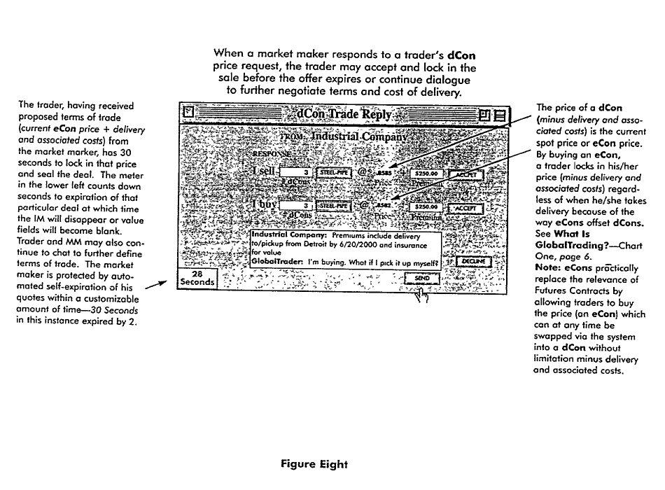

The market maker facing a request from a trader or market maker for price(s) for purchase and/or sale of delivery of an asset defined by a specific eContract (a request for a dCon) can decline to respond or respond with his or her terms of trade. In FIG. 8, Industrial Company responds to GlobalTrader's request for a price on 3 dContracts with delivery to Detroit. Industrial Company spells out the terms of trade by saying “Premiums include delivery to/pickup from Detroit by Jun. 20, 2000 and insurance for value. When a market maker responds to a trader's dCon price request, the trader may accept and lock in the sale before the offer expires or continue dialogue to further negotiate terms and cost of delivery. Here, the terms and their elaboration by means of instant message dialogue become the terms of any resulting commitment that is a dContract. In FIG. 8, GlobalTrader further specifies the terms by saying “I'm buying, what if I pick it up myself?” The market maker can then respond in kind by lowering his price or however he or she chooses. If the initiator of the trade is satisfied with the terms as specified in his or her private negotiation with the market maker, then he or she can lock in the price and commit by clicking “accept” which will initiate the GT system to sell the initiator's long position (if, as in this case with GlobalTrader, he or she has one), credit or debit said trader's account for amount equal to the value of the difference between the current spot price and the price of the eContract held long (here, Global would be credited an amount equal to the difference between the value of a steel-pipe eContract at 0.8585 and the same at 0.8520), and debit the same trader's account for the full cost of the dContract (the underlying value of the eContract) at current spot price plus the agreed delivery and associated cost premium. On the market maker's side, given that Industrial Company is selling, once the dContract is committed, Industrial Company's account is credited for an amount equal to the value of one dContract of steel-pipe at the current spot price plus agreed delivery and associated cost premium.

A more detailed example of a transaction involving the swapping of eContracts for dContracts relative to the circumstance of a watch company is given above.

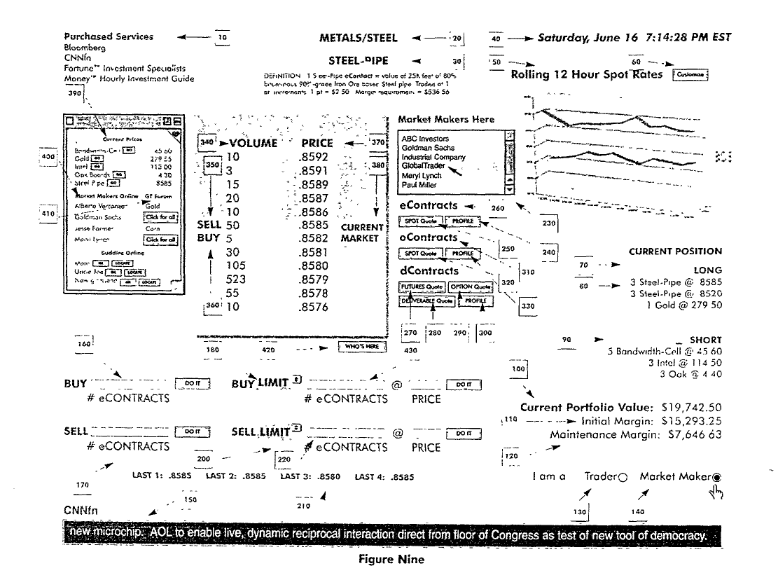

FIG. 9 shows GlobalTrader designating himself as a market maker. Note item 140 and the list of item 230, which now shows GlobalTrader as a market maker. The significance of this feature of the GT system is elaborated above. Also, note again how the portfolio balance of GlobalTrader again changes based upon fluctuations in price over time as illustrated by comparing and contrasting the specifics of items 390 and 40 in both FIG. 4 and FIG. 9 because of his positions being marked to market.

FIG. 10 shows a screen displayed to the trader with an alert notifying the trader that his or her limit order for bandwidth is being approached. Also, note again how the portfolio balance of GlobalTrader again changes based upon fluctuations in price over time as illustrated by comparing and contrasting the specifics of items 390 and 40 in both FIG. 4 and FIG. 9 because of his positions being marked to market.

FIG. 11 shows how the price of an eContract guarantees the price for purchase and delivery of the same relative underlying asset over time by means of the dContract. The dContract price is the current spot price minus delivery and associated costs. Any up or down swings in price after the purchase of the price (by buying an eContract) is offset in the conversion of an eContract to a dContract as explained in detail above.

FIG. 12 shows the percentage of trades that did and did not take delivery on the CME Exchange for a period of one month on 5 different commodities.

### Partial Review of Features of the GlobalTrading System

A Trading is available globally 24 hours a day, 7 days a week, 365 days a year to everyone who wants to access and participate in an actual forum of the GT virtual exchange. No other exchange in the world provides such access or opportunity.

B Funds are guaranteed. Loss because of non-payment is prevented in the system of the invention.

C GT ensures small traders are treated fairly because small and odd lot transactions are the first traded at any price and the central order book for the current spot price (the eContract price) as well as the central order book for the current oContract price both publicly display all pending and active orders in each specific GT forum.

D Trading in eCons provide a very inexpensive, cash-guaranteed, streamlined alternative to trading in-and-out-of futures contracts and other trades when the trader does not want or need to take delivery or does want to take delivery but is not sure of when.

E A single interface to place, protect, and hedge positions as well as take/arrange delivery of assets. The GlobalTrading system is a full featured, cash-guaranteed trading system with a built-in hedging mechanism that provides pure disclosure of collective order books, open access to everyone that can establish credibility, enables said individuals and/or companies to act as market makers in the exchange as well, is itself neutral to all trades, employs operating methods that provide small and medium-sized players and owners of all types of assets the same tools, efficiencies, and opportunities only available in the legacy market system to the select professional investor and big players.

F Trader's funds are more liquid on a daily basis instead of being tied up for months at a time as with a traditional futures contract. Only eCash guaranteeing current open positions is tied up.

G Charting tools are also available to traders for sophisticated evaluations of the markets to assist with trading decisions. A trader may set his/her own parameters for each specific market, intraday, 5 minute, 30 minute, hourly, or daily, high, low, close and volume charts. For an additional fee, traders may access proprietary charting tools to synthesize market data such as Bolinger Bands, Stochastics, Elliot Wave or Japanese Candlestick parameters. As an option, constant customizable information feeds scroll across the trader's screen. Live notification of market-related developments pop up in windows as they happen such as fast-breaking news, weather reports or economic number releases.

H Inexpensive. Traders are trading on-the-spot, therefore, they will not have to close positions at the end of a delivery month and swap to another forward month should they want to keep a position on, as traders must do when dealing with traditional future or option contracts. This activity costs traders substantial money in the current markets. Furthermore, individual traders trade directly with each other, thus reducing costs. Considered in part or completely, GT offers tremendous cost efficiencies and incentives to participate for both large and small investors.

I In the GlobalTrading market system, the trader is the market. In the traditional markets, unless one is a seated member of an exchange, one cannot trade in the pits or act as a market maker. GT swaps the pit for an Internet forum. Trading in GlobalTrading forums is similar to trading in actual “outcry” pits, except that the “exchange” is virtual and open.

J Market orders are handled immediately and one sees other orders and what is above and below, before and after it. In traditional markets, one trades with a brokerage house, and one must call the broker, who then in turn calls or electronically sends the order to the floor where it is then manually processed. In the GlobalTrading forum, the trader bypasses this complexity and trades live and directly with other buyers and sellers as if on the floor him/herself. The GT system notifies traders immediately that his or her orders are registered or filled and instantly updates their accounts and portfolio values. In traditional markets, response times for the individual investor on whether a trade was executed may take up to an hour.

K A trader knows his/her position all the time. For example, upon signing on, the trader is presented with a text and voice message saying “Welcome. You've got mail. Your current portfolio balance is $X.” Traders have a small persistent window on the screen that lists current prices of markets in which they have a position or interest traveling with them whenever they are online. The value of each portfolio is tied to the current market and the last trade determines the value of open positions. The system updates and reports a trader's value instantaneously, continuously.

L Automatic stop limits are put into place when one enters into a contract. These are able to be customized at the trader's discretion, but could never exceed 90% of the market value of the traders current eCash on hand.

M Pop-up windows warn traders when they are getting close to margin stops being activated. Traders have the option to use a pager, email or phone call notification (or all three).

N Customized pages allow traders to watch different markets and change what they see as they determine.

O Trading spot all the time keeps price consistent with cash value.

The trader will not have to take into consideration value differences from spot to forward, with demand, supply and interest-rate premiums and discounts in the future.

P The GlobalTrading forum facilitates international as well as domestic trading. All markets are streamed through the single GT medium.

Q Markets are as narrowly focused and diverse as the market demands. Via the one GT system, traders have many more options than before to spread one market sector against another possibly quite different one in order to provide liquidity, a more secure and diversified trading portfolio, and a more stable market place.

While the invention has been described herein with reference to certain preferred embodiments, these embodiments have been presented by way of example only, and not to limit the scope of the invention.

### Appendix 1—Glossary

Arbitrage—Arbitrage is when a price variance occurs in markets of similarly-based products. A trader known as an arbitrageur buys and sells these similar products simultaneously to take advantage of his or her price discrepancy.

At The Money—Term used in options to define whether an option's strike price is right at or near the current market price. A Canadian dollar call or put with a strike price of 0.6400 is considered at the money if the current market is near this strike price, for example, 0.6398. But a strike price of 0.6300 is out of the money if buying a put and in the money if buying a call because of 0.0098 in intrinsic value. See Time Value, Volatility Value, & Intrinsic Value.

Call—An option to call away from another trader the underlying asset contract at a specific strike price by a specific date. After that date the option is said to have expired. If the option is out of the money, it is said to have expired worthless. If the option has intrinsic value it should be exercised and either sold for the value or held as an open long position. If one owns a call option, one is expecting the market to go up in price. “Call-up,” “put-down” is how one wants the market to move when one owns each respectively. If one has a call one wants the market to go up. If one has a put, one wants the market to go down to make money. See Time Value, Volatility Value, & Intrinsic Value.

Central Order Book—Term used to define an information matrix continuously displayed in a specific GT forum listing all pending and active buy and sell orders and their respective prices.

Current Portfolio Value—The current amount of eCash one has on hand. One secures eCash by placing a deposit or reserving a liquid line of credit with a participating federally regulated bank.

dContract—A new financial instrument and trading tool. The vehicle for separating the delivery of an asset from its price. An electronically facilitated privately negotiated commitment to sell/buy at spot (eCon) price plus delivery and associated costs and make/take delivery. Delivery and its associated costs, issues and risks are the responsibility of the buyer and seller. Specific terms and costs of delivery are negotiated privately via the GT system interface. The specific terms as worked out by GT instant message between the buyer and seller are upon commitment the terms of a legally binding contract. Costs when dealing with commodities such as pork bellies or cattle that may have minor unavoidable differences between one delivery that meets the contract definition and another that does the same are included in the associated costs negotiated and accommodated in the terms specified by the buyer and seller. As terms of the negotiation, a buyer may request that a seller provide proof of the delivered product having been certified by some governing or certifying body such as the FDA. A buyer may also request that his purchase be insured and that cost factored into the delivery and associated costs.

Draw Down—The drawing down of additional margin to cover a position beyond the initial margin amount because of market losses. Needing to increase one's amount of eCash.

eContract—A new financial instrument and trading tool. An electronically facilitated commitment to guarantee or hedge a price on a specific underlying but non-deliverable asset. An eContract does not have a term, maturity or expiration date. eContracts or eCons are traded at the cash or spot price. eContracts are privately negotiated agreements based upon guaranteed value that enables both parties to exert greater and more direct influence over terms of trading and price. No trader can or will every take deliver of the underlying asset when trading strictly in eCons, but trading activity (unless a wash) will either increase or decrease the amount of eCash he/she has. The present price of an asset is based on the actual “on-the-spot” price and therefore does not expire like a commodity or future contract. eCons could also be described as guaranteed counterparty-to-counterparty cash/credit exposures between agreeing financially established concerns. Technically, a trader does not buy an eCon, he/she reaches a private agreement to trade in our forum and the value of that trade is guaranteed and accounted by GlobalTrading—this commitment and its value is the eCon. An eContract can be converted into a dContract if and when delivery of the asset is desired.

eCash—Currency of the online world. Enables individuals and investors alike to enter and trade in global markets. eCash is money in the bank or funds guaranteed by a bank to serve as an electronic financial credit either for making binding financial commitments through privately negotiated agreements (see eContract and dContract) or to purchase products or services offered, at least on GT, if not online in general. A bank takes a deposit in a liquid money market, time deposit or a savings account. It gives the depositor an account number and an electronic pass code. The basics of these accounts are that credits and debits is based on trading positions and profits as the market moves, potentially each second. One's eCash balance goes up or down based on those moves. An eCash account must be set up before any trading is done and the trader must read warning and disclaimer pages and commit to agree to maintenance, trading and similar rules. eCash is currency in the virtual world and is used as ubiquitously as cash in the real world. A trader's eCash account is updated with market movements as they happen in real-time. Settlement occurs at least once a day. Note: settlement in GT does not have the same significance as settlement in the current exchanges. The GlobalTrader's portfolio balance is the same at settlement time as it is even if “settlement” in the traditional sense were not done. Settlement occurs, at least, once daily in GT as a basis to determine yield and to generate technical evaluative information consistent with current market analytics. A trader may use the balance of his or her eCash account to pay for products or services offered on-line, keep eCash on hand, or transfer part or all the balance (dollars or equivalent foreign currency) to his or her individual bank account or elsewhere.

Exercise Price—To exercise a price of an oContract means the buyer of a put or a call has some intrinsic value and wishes to exercise his/her option. If the buyer of a call wishes to exercise his/her option, then he/she takes delivery of the applicable future contract and takes an outright long position. If the buyer of a put wishes to exercise his/her option, then he/she will deliver the applicable futures contract to another person taking an outright short position.

Futures Contract—Unlike stocks, which represent ownership in a company and can be held for a long period of time, futures contracts have finite lives. In the US, these contracts are mainly used for hedging against commodity price fluctuations rather than for the buying or selling of the actual cash commodity. In Europe, futures contracts are also traded on individual securities. A futures contract is defined as a legally binding agreement, made on the trading floor of the exchange, to buy or sell a commodity (or financial instrument) at a specified time in the future. Futures contracts are standardized according to the quantity, quality, and delivery time and location for each commodity. The only variable is price, which is discovered on an exchange floor. See: http://www.tradingfutures.com/futurescontract.html

Future Markets—Futures Markets are based on contracts. In the traditional commodity exchange system, a contract traded is a commitment to buy or sell a specific amount of a commodity to be delivered in the future at a specific date in time. At expiration date, the contract is either covered or the commodity delivered to the buyer. GlobalTrading eCons trade only on price and not on actual commodities even though it is the price of the underlying asset relative to evolving market conditions. Because an eCon is based on the current cash price and not the future price, it more accurately represents the current market value of the underlying asset. eCons do not expire like future contracts yet achieve a majority of the same goals. With eCons, traders never need to swap out of one month and into another incurring double brokerage fees just to keep the same position on. As long as the eCon is active, has not been offset and the position remains above any stop limit established either by the trader or by GlobalTrading rules, a position can remain on with no recourse, allowing for a truer and much less costly hedge than the current markets. The values of trades in eCons are guaranteed by GlobalTrading (via eCash) thus eliminating as a consideration risk of loss to either side of a transaction. The large majority of futures traders in current markets neither want nor need to take delivery of the underlying asset. As a result, traders dealing in traditional futures must endure the complicated and costly necessity of trading-in-and-out-of-contracts because of his or her regular, built-in expiration. eContracts serve the intention of traders without the traditional difficulties. Unlike future contracts, with GlobalTrading there is no need to deal with delivery of the underlying asset because a futures contract was mistakenly left un-swapped with a new contract. See dContract and oContract.

GlobalTrading (GT)—A full-featured, cash-guaranteed system that enables anyone to buy, sell, and/or hedge any asset or service which does or may exist all via one online interface accessible through any Internet device. A pure cash market. Traders taking long and short positions in GlobalTrading—trading eCons or oCons—are not owning or selling the actual underlying stock or commodity. Traders are simply taking a long position or short position on the price. Every trader that trades in GT has a portfolio balance guaranteed by a member bank earmarked as eCash. eCash funds would not be block and is used to purchase other things, but when a trade is put on, an amount equal to margin must be available and is blocked until the position was reduced or closed. Each eCash account is marked to market as the market moves, potentially second-to-second. The value of each trader's portfolio is based on the current market, and its balance is reduced if he/she lost money or increased if he/she made money. Any funds over required margin amount is available for additional positions, online purchases or to transfer elsewhere. Each trader may customize his or her trading limits, but the GT system automatically sets conservative absolute limits with guaranteed stops. If the market moves against the trader and his/her stop limit is hit, then the next available bid is matched if the trader is long and the next offer is paid if the trader was short and the position is closed. A trader has the ability to customize his or her stops, but every trader has built-in stops in the market equal to no more than 90% of his or her portfolio. This is the same for institutional accounts or for individual accounts. No trader is exempt. A trader has the ability to move funds (sweep accounts) that are not being used for margin into an interest bearing account at a participating bank to earn interest on his/her unmargined funds.

In The Money—An option or oContract that is in the money is an option with some intrinsic value. An option can be at the money and in the money at the same time. Given a strike price of 0.6400 and a market of 0.6398, a trader have 0.0002 of intrinsic value if buying a 0.6400 put because he/she is able to immediately put it to the buyer of the option at 0.6400 and then buy it in the current market at 0.6398 thereby making a 0.0002 profit. See Time Value, Volatility Value, & Intrinsic Value.

Lead Month—The lead month is the primary month traded in the traditional futures trading pits. It is also the most active month traded. This does not mean that other months are not traded, but the majority of trade volume at any given time is in the lead month. As a future contract reaches maturity and expiration, it is gradually traded less and less until the last few days when the only trading done in that contract is just squaring up of outstanding positions that have not been offset.

Limit Order—Trader sets a particular price at which he/she wants to buy or sell. A buy limit order is a purchase below the market. If the market never dips to that price, one never buys it. A sell limit order is a sell above the market. If the market never reaches that price, one never sells it. Some traders decide to enter the market with these, but typically limit orders are profit orders.

Liquidity—Ease of order execution. Liquidity makes or breaks any system. Liquidity is in direct relation to volume. With more of the latter comes more of the former. A 24/7 and Internet-based exchange like GlobalTrading attracts more individual traders into the market, providing greater liquidity and greater stability. The way markets are traditionally made, unnecessary market fluctuations can be seen in the final hours of a trading day when traders and portfolio mangers alike try to square up positions. This rushing to square positions in the thinness of the last 10 or 15 minutes of a closing market causes greater fluctuations than necessary. GlobalTrading and its built-in hedging mechanism eliminates the need for these late-day erratic market swings. GlobalTrading is another mechanism for institutions trading in actual products to trade and hedge themselves during times when the traditional market is closed. In the GT forum, traders are not required to close out their positions at the end of a trading day because he/she can put in stops that take effect at the applicable time during the 24/7 motion of the market. GlobalTrading makes it easier to hedge because not only is the cost to make an initial position less expensive, but also because traders will not have to endure costs associated with constantly closing out and replacing positions. This results in less market volatility and more market liquidity.

Long—A long position means that one owns a specific eContract, dContract or oContract. The ownership of it makes a trader long. A long position on an eContract or oContract means the trader has bought either the price or an option to buy the price respectively typically with expectation that the price will go up presenting the opportunity to sell it later at a higher price.

Maintenance—The minimum amount of eCash that must be on hand to secure a given position having met initial margin and taken a position in a given market. Maintenance amounts control a larger value and, in GT, are potentially the same as its built-in stop orders. In GlobalTrading, maintenance requirements are more flexible than in traditional markets because GT automatically covers a trader's positions and removes them from the market once they reach 90% of his or her eCash.

Margin—The amount of eCash necessary to take a position in a given GT market. Margin amounts are distinct from maintenance amounts. Default maintenance in GT is 50% of initial margin entry amount. Maximum maintenance is between 90%. In traditional markets, margin is borrowing money from a broker to buy a stock or commodity using ones investment as collateral. Investors generally use margin to increase his or her purchasing power so that they can own more stock or commodity without fully paying for it. How a trader guarantees his/her eCash, be it by cash deposit or established line of credit with a bank, has no special significance to GlobalTrading for whom the bottom line is that all trades are cash-guaranteed. In the interest of protecting those who would harm themselves by trading recklessly, GlobalTrading would encourage small investors, whenever practically possible, to guarantee his or her eCash with cash.

Market Maker—A trader willing to make prices, both bids and offers to other traders to maintain market liquidity. Market makers are typically from larger institutions and banks that can always be in the market and are willing to make prices even when the market is highly volatile. Market makers are necessary to the liquidity of the market. Market makers are usually day-traders seldom in the market for more than a few minutes. They are in and out many times over the course of a day, but they provide much of the liquidity that is necessary for the market to stay fluid. A market maker can make money even in a non-moving market, because he/she is quoting a bid and an offer. The perfect situation for a market maker is lots of volume and little or no movement because he/she is taking a one or two tick spread all day long with no movement. The nature of the market is that as the market makers become longer in his or her portfolio, the market should be going down because that means people are selling. If the market maker is short in his hand, then the market should be going up. The art of being a market maker is to know how to buy and sell to anticipate these moves. GlobalTrading offers each participant the opportunity to assist the market with pricing and liquidity by trying his/her hand at being a market maker.

Market Price—The market price is the most current price quoted for a specific market—the highest bidding price (buying price) and the lowest offering price (selling price). For example: A long position has to be sold to get out of the position. The current market bid or buying price is used to close this position. In turn, a short position has to be marked to the current offer or sale price because a short position is offset by buying. GlobalTrading reconciles accounts constantly with reference to the current market price.

oContract—A new financial instrument and trading tool. An option to buy an eContract. In the GT system, oContracts orders have no initial intrinsic value, but the system continuously calculates their spot price using an algorithm based upon time value and volatility value. The depreciation of both time value and volatility value of an oCon is in direct relation to fluctuations in price. oCons develop intrinsic value, but initial pricing by the GT system factors in no intrinsic value. Time value depreciates itself. Volatility value depreciates on itself and time. In general terms, the value of the oCon each moment is calculated by a formula based on the ratio value of the period of time remaining in the option and the average volatility value of the preceding days over the period of time of the initial option itself and by adding in any appreciated intrinsic value. For example, say an oCon is for 30 days. Its value each day is calculated by a formula based on the ratio value of number of days remaining, say 27, and its relation to the average volatility of the past 30 days and by adding any appreciated intrinsic value.

Odd Lots—In GlobalTrading, small odd lots are matched first to protect the small investor. The GT odd lot rule is a transaction less than 10 contracts is first out. Ten or above is first-in, first-out. Odd lots less than 10, were they multiple, are matched first-in first-out in his or her own category.

Options—Options are simply an option to buy or sell an asset at a specific time in the future. For that option one pays a premium that gives one that right. A trader may exercise this right at anytime he/she so chooses during the life of the option. If the option has no intrinsic value at maturity, it will expire worthless. The price and value of an option is calculated by consideration of three factors—time value, volatility value and intrinsic value. See Time Value, Volatility Value & Intrinsic Value.

Out Cry Pits—The term for futures trading pits as they are traded traditionally. Traders call out prices to each other and use physical gestures to communicate in a live pit forum to transact their business.

Out Of The Money—Any option that lacks intrinsic value is said to be out of the money. For example, a 0.6400 strike price with the market at 0.6398 is out of the money for the buyer of a call by 0.0002. Because the trader has the right to buy the underlying asset (in this case Canadian dollars) at the strike price of 0.6400 and the market is below this at 0.6398, the option is considered out of the money. An out of the money option can be an at the money option too because it is the closest strike price to the current market price.

Put—A put option is an option to put to another trader an underlying asset at a specific strike price by a specific date. Just like a call, one can exercise one's option at any time during its life. One does not have to wait until expiration day. Just like a call option with no intrinsic value, a put option with no intrinsic value at expiration is said to have expired worthless. “Call-up,” “put-down” is how one wants the market to move when one owns each respectively. If one has a call one wants the market to go up. If one has a put, one wants the market to go down to make money. See Time Value, Volatility Value, & Intrinsic Value.

Settlement—Each account participating or maintaining an active balance in GlobalTrading is marked to the market as the market moves, normally second-to-second but no less often than once per day. Profit or loss is accounted continuously. Any eCash balance left less margin held to cover current positions is available for the trader to use or transfer at his/her discretion. Note: settlement in GT does not have the same significance as in the traditional exchanges. The GlobalTrader's portfolio balance, which updates in real-time marked to market moves is the same as it is at settlement time even if settlement were not done. Settlement occurs at least once daily as a means to determine yield and generate technical evaluative information consistent with current market analytics.

Short—A short position means that a trader has sold a specific asset at a specific price, but does not yet own it. This lack of ownership makes the trader short. A short position means a trader sold the price typically with expectation the price will go lower presenting the opportunity to buy it later at a lower price.

Specialist—A specialist is the market maker of the traditional stock markets. He/she stands at what is called a post at a stock exchange and quotes prices to buyers and sellers all day. This specialist controls the market and the spread between bid and ask. His profit comes from the difference between where he buys and sells. This specialist is the same as the market maker in the commodity pits except there are many market makers in the commodity pits. Market liquidity determines the spread. GlobalTrading enables all traders to act as market makers.

Spot Trading—Is a currency term, but can apply to other assets too. Each currency transaction takes two business days to settle when trading for cash. If one commits to purchase D-marks traditionally from bank X for dollars, then the transaction is confirmed either today or tomorrow and the wire is sent by both parties on the second day. Bank X delivers D-marks, and one delivers to Bank X its dollars at the same time. This is what spot transactions are. A currency trade done outside the current time frame has interest rate differential implications, and the spot price is adjusted to compensate both parties for the interest differential between the two countries. Any commodity trade done outside the current time frame has an array of other factors that add discounts or premiums to its price in the future.

Spread/Swap Transactions—According to the way futures are traditionally traded, a trader must be square (balanced in his/her account) on the maturity date or final date of the applicable future date or risk being delivered the underlying commodity if he/she is in a long position or risk having to deliver the underlying commodity to a buyer if he/she is in a short position. To maintain the current long or short position, a trader must do what is called a swap or spread. If a trader is long in a market, he/she must sell the expiring contract and buy the next applicable month contract. This squares up the current contract, so there is no risk of delivery and maintains the long position by buying a next month's contract(s). If the trader is short then the exact opposite transaction takes place—the trader buys the current contract and sells a contract somewhere in the future to maintain the same position. This is simply swapping one contract for another. Note that when a trader does this, he/she may be losing some of the value of the contract because of premiums or discounts to the future prices (see Spot Trading). Swap is more a currency term, but it applies to all commodities. A spread is an actual market order that allows a trader to trade one month against another or one similar commodity to another. Many market complexes trade in tandem with, for example, the financial instruments. If interest rates are going up, they typically are going up on 5 and 10-year notes as well as the 30-year bond, T-Bills and Eurodollars. Larger movements may occur in the whole interest rate complex, but there are also variances in the market as one interest rate security moves faster or slower than another interest rate security. Trades that take advantage of these movements are called spreads. For example: a trader might want to spread a T-Bill contract against the 30 year bond because he/she thinks the yield curve will flatten out or get steeper. The trader might want to spread corn against wheat because he/she thinks that the corn crop will not be as good as the wheat crop this year. A trader might want to spread gold versus silver because he/she thinks that Reserve Banks are selling their gold reserves and that silver's price is going up because of commercial demand. These are examples of spreads. The order accomplishes the same result when one is already in a position and one needs to swap into another month. One is not putting on a spread position, but one is using a spread order to maintain one's long or short position. All the order does is sell the current month and buys the future month if one is long and buys the current month and sells the future month if one is short, thereby maintaining one's current position.

Stop Order—Stop orders protect traders by getting them out of a moving market to minimize losses or because they cannot afford to stay in. If one is long a position and one activates a stop, one's stop is below the market. If one is short a position and one activates a stop, it is above the market. Stop orders protect against adverse movements in the market. Some traders decide to enter the market with stop orders, but generally stop orders are pain threshold limits and used to protect against loss.

Strike Price—Price at which an option or oContract may or may not be exercised. This price may be above, below or at the current market. If its price is at the current market, it is called at the money. If it is below the current market (for calls and above the market for puts), then it is called out of the money. A call below the market with intrinsic value is known as in the money. It is the opposite for puts. Puts have to be above the market to have intrinsic value.

Time Value, Volatility Value, and Intrinsic Value—Options or oContracts are priced based on three different criteria. All options have the first two, which are time value and volatility value. The longer the option life, the higher the time value is. The more volatile the market has been in recent history, the higher the cost of the option. So time value looks forward and volatility value looks back. Any option in the money is considered to have intrinsic value, which means the option has a cash value. For example, if a call option in the Canadian dollar has a strike price of 0.6400 and the current market is 0.6420, there is 0.0020 of intrinsic value to this call option. The trader holding this call is able to exercise his or her right to buy at 0.6400 and then sell immediately in the current market at 0.6420 to make 0.0020 in profit. The price of any option takes into consideration these three values and adds them together to calculate the option price. As the option nears its expiration date, time value and volatility value will depreciate to zero leaving intrinsic value the only possible value. If an option is out of the money at expiration, then it is said to have expired worthless. See options and oContracts.

Trader—Someone that trades in a market to buy and sell goods, services, eContracts, dContracts, oContracts or other instruments or assets for the profit of his own personal account. See market maker.

What is claimed is:

1. A method of trading instruments based on the price of assets over a global communications network such as the Internet, comprising:
establishing a plurality of instruments, each comprising a transferable contract representing the price of a standardized but nondeliverable quantity of a commodity, security, service or other asset;
establishing an Internet Web site operated by a data processing and page serving system to operate as a virtual marketplace for the trading of said instruments;
receiving a bid at said Web site sent via the Internet from a first trader to buy at least one of said instruments at a bid price, and an offer at said Web site sent via the Internet from a second trader to sell at least one of said instruments at an offer price, or vice versa; and
automatically or by private negotiation facilitating execution at said Web site a transation for the purchase and sale of at least one of said instruments when said bid price equals said offer price.

2. The method of claim 1 in which at least one of said traders is a market maker.

3. The method of claim 1 in which each of said instruments is convertible into a second contract representing a deliverable quantity of and delivery terms for said asset.

4. The method of claim 3 in which said second contract may be independently purchased or sold and facilitated and accounted for by said site in similar manner and relative to said price of said first contract.

5. The method of claim 1 in which each of said instruments is secured by electronic cash.

6. A system for trading contracts over a global communications network, comprising:
a system for establishing a plurality of eCash units, each eCash unit representing a trading credit guaranteed in advance by physical or bank-guaranteed cash or credit, and each eCash unit being stored in a trading account;
a system for establishing, storing, organizing, transmitting and displaying information for a plurality of transferable eContracts, each eContract having a variable price and representing the price of a non-deliverable quantity of a commodity, security, service or other asset and each eContract further being guaranteed or paid for by said eCash units;
a system for establishing, storing, organizing, transmitting and displaying information for a plurality of dContracts, each dContract having a price and representing a deliverable quantity of and delivery terms for a commodity, security, service or other asset and each dContract further being guaranteed or paid for by said eCash units;
a system for establishing, storing, organizing, transmitting and displaying information for a plurality of transferable oContracts, each oContract having a price and representing an option to buy or sell one or more of said eContracts, and each oContract further being guaranteed or paid for by said eCash units;
a system operated through an Internet Web site for receiving and automatically facilitating, calculating, executing, settling and recording buy and sell orders in a trading forum for the purchase and sale of said eContracts, dContracts and oContracts, according to terms of private negotiation or on an odd-lot basis first and then on a first-in, first-out basis, so as to facilitate and account for trades and establish a marketplace for said eContracts, dContracts and oContracts over a global communications network;
a system for automatically and continuously settling said trades;
a system for automatically and continuously crediting and debiting said trading accounts concurrently with said settling;
a system for converting eContracts into dContracts at the discretion of owners of said eContracts who wish to take delivery of said commodity, security, service or other asset underlying said eContracts; and
a system for displaying the results of said trades remotely in real time.

7. A method of trading contracts over a global communications network, comprising:
establishing a plurality of trading accounts;
establishing a plurality of eCash units, each eCash unit representing a trading credit guaranteed in advance by physical or bank-guaranteed cash or credit;
receiving physical cash, and converting said cash into said eCash units;
establishing a plurality of transferable eContracts, each eContract having a variable price and representing the price of a non-deliverable quantity of a commodity, security, service or other asset and each eContract further being guaranteed or paid for by said eCash units;
establishing a plurality of transferable dContracts, each dContract having a price and representing a deliverable quantity of and delivery terms for a commodity, security, service or other asset and each dContract further being guaranteed or paid for by said eCash units;
establishing a plurality of transferable oContracts, each oContract having a variable price and representing an option to buy or sell one or more of said eContracts, and each oContract further being guaranteed or paid for by said eCash units;
establishing an Internet Web site for operating at least one trading forum and a virtual marketplace for the purchase and sale of said eContracts, dContracts and oContracts over a global communications network;
receiving at least one buy order to purchase at least one said eContract, dContract or oContract at a specified bid price;
receiving at least one sell order to sell at least one said eContract, dContract or oContract at a specified offer price;
automatically facilitating, calculating, executing, settling and recording, according to terms of private negotiation or on an odd-lot basis first and then on a first-in, first-out basis, all said buy and sell orders in which the bid price equals the offer price, so as to generate one or more trades;
automatically and continuously settling said trades;
automatically and continuously crediting and debiting the trading accounts of said traders to reflect the mark-to-market value of each of said trading accounts as a result of each said trade;
selectively converting eContracts into dContracts at the discretion of traders wishing to take delivery of said commodity, security, service or other asset; and
displaying the results of said trades to participants in said forums in real time.
